(19) United States
(12) Patent Application Publication
(10) Pub. No.: US 2024/0181795 A1
(43) Pub. Date: Jun. 6, 2024

(54) IMAGE FORMING METHOD, IMAGE FORMING SYSTEM, POSTPROCESSING LIQUID, AND POSTPROCESSING LIQUID APPLYING APPARATUS

(71) Applicant: Konica Minolta, Inc., Tokyo (JP)

(72) Inventor: Naoki YOSHIE, Ibaraki-si (JP)

(21) Appl. No.: 18/498,157

(22) Filed: Oct. 31, 2023

(30) Foreign Application Priority Data
Nov. 21, 2022 (JP) 2022-186010

(51) Int. Cl. B41M 5/00; B41M 7/00; C09D 11/101; G03G 15/20

(52) U.S. Cl. CPC B41M 5/0023; B41M 7/0081; C09D 11/101; G03G 15/2098; B41J 11/00214

(57) ABSTRACT

An image forming method includes: forming an image with a printing material containing a wax on a recording medium: applying a postprocessing liquid onto the image as postprocessing; and forming a layer of the postprocessing liquid, wherein an interfacial tension of the postprocessing liquid to water is within a range of 2 to 13 mN/m at 25° C.

### CROSS-REFERENCE TO RELATED APPLICATIONS

The entire disclosure of Japanese Patent Application No. 2022-186010 filed on Nov. 21, 2022 is incorporated herein by reference in its entirety.

### BACKGROUND

### Technical Field

The present invention relates to an image forming method, an image forming system, a postprocessing liquid, and a postprocessing liquid applying apparatus. More specifically, the present invention relates to an image forming method and an image forming system for excellent application property of a postprocessing liquid to a fixed image and for excellent adhesiveness after application of the postprocessing liquid, and to a postprocessing liquid and an applying apparatus applying the postprocessing liquid that are suitable for the method and the system.

### Description of the Related Art

In recent years, post-press processing (processing in the process of transition to printing) has become important in the production printing area.

Examples thereof include varnish processing, lamination processing, paste processing, and processing by supplying a decorative agent such as a foil, and processing by using a liquid such as varnish processing is particularly important at the time of image formation.

Examples of an object to be processed using a postprocessing liquid as described above include a package, a label, a direct mail (DM), and a photo book.

Digital printing is often used in image formation in recent years, and examples of printing materials used therein include toner and ink. The printing material often contains wax as a release agent for toner or a gelling agent for ink.

Since the wax has low affinity with, for example, a general varnish having a polar group, if the varnish is applied to the image formed by using the digital printing as described above, the image easily repels the varnish, and thus there is a problem in that the varnish is hardly uniformly wetted (application property of the varnish with respect to the image is deteriorated).

For that, Japanese Unexamined Patent Publication No. 2011-191536 discloses a technique in which a wax having a polar group is made to be contained into toner particles for image formation to enhance the application property of a varnish to an image.

Note that in the present specification, the term “application property” refers to the wettability of a liquid with respect to a fixed image.

The above-described technology limits the type of wax contained in a toner when the toner is used as a printing material, hence there is a problem that the range of toner design is narrowed.

As another method of improving the application property of the varnish to the image, for example, a method of making the surface tension of the varnish smaller than the surface tension of the image, thereby controlling the surface tension difference between the varnish and the image is considered.

However, since an image with wax contained in a printing material has a low surface tension and the surface tension of varnish has a lower limit, there is a problem that sufficient application property cannot be obtained only by controlling the surface tension difference between varnish and an image.

In particular, in the case where an image is formed with a printing material containing an ester wax having high crystallinity, the surface tension of the image becomes lower, and therefore, the problem that the application property cannot be obtained becomes more remarkable.

In order to solve this problem, it is considered to improve the application property by performing a pretreatment (corona treatment) on the image to increase the surface tension of the image. However, an apparatus for performing such a pretreatment is expensive, and many printing companies do not have the apparatus.

In addition, by performing the pretreatment as described above, there is a problem that a pretreatment step is added in addition to normal steps at the time of printing.

### SUMMARY

The present invention has been made in consideration of the above-described problems and situations, and objects thereof include providing an image forming method and an image forming system for excellent application property of a postprocessing liquid to a fixed image and for excellent adhesiveness after application of the postprocessing liquid, and a postprocessing liquid and an applying apparatus applying the postprocessing liquid that are suitable for the method and the system.

In order to active the abovementioned object(s), the present inventors have studied the causes of the problem(s) and the like, and as a result, have found that the problem can be solved by applying a postprocessing liquid having an interfacial tension to water controlled to be within a specific range onto an image formed with a printing material containing a wax, and have completed the present invention.

That is, the aforementioned problem is solved by the following means.

According to a first aspect of the present disclosure, there is provided an image forming method including:

forming an image with a printing material containing a wax on a recording medium;

applying a postprocessing liquid onto the image as postprocessing; and

forming a layer of the postprocessing liquid,

wherein an interfacial tension of the postprocessing liquid to water is within a range of 2 to 13 mN/m at 25° C.

According to a second aspect of the present disclosure, there is provided an image forming system including:

an apparatus that forms an image with a printing material containing a wax on a recording medium;

an apparatus that applies a postprocessing liquid onto the image as postprocessing; and

an apparatus that forms a layer of the postprocessing liquid,

wherein an interfacial tension of the postprocessing liquid to water is within a range of 2 to 13 mN/m at 25° C.

According to a third aspect of the present disclosure, there is provided a postprocessing liquid that is used in the above image forming method, wherein an interfacial tension of the postprocessing liquid to water is within a range of 2 to 13 mN/m at 25° ° C.

According to a fourth aspect of the present disclosure, there is provided a postprocessing liquid applying apparatus that is used in the above image forming method, wherein the postprocessing liquid applying apparatus applies a postprocessing liquid onto an image formed with a printing material containing a wax.

An expression mechanism or an action mechanism of the effect of the present invention is not clear, but is assumed as follows.

In the present invention, a postprocessing liquid is applied as postprocessing onto an image formed of a printing material containing a wax (which hereinafter, in the present invention, may be simply referred to as a “fixed image”).

Here, in the present invention, the term “postprocessing” refers to the first processing treatment that is performed on a fixed image, such as application of a postprocessing liquid to a fixed image.

The “postprocessing” includes a series of processing treatments on the postprocessing liquid or the layer of the postprocessing liquid, such as drying or curing after application of the postprocessing liquid.

Note that the surface tension to water of the postprocessing liquid to be applied to the fixed image is within a range of 2 to 13 mN/m at a temperature of 25° C.

In general, it is considered that the application property (wettability) of a liquid to an image (solid surface) is improved as the surface tension of the liquid is lower than the surface tension of the image.

When a printing material contains a low surface energy component, such as a wax, the component bleeds on the surface of the image, so that the surface energy of the fixed image decreases.

The fixed image has a low surface tension, and generally, when the liquid is applied to the fixed image, the surface tension has to be lower than the surface tension of the liquid, resulting in poor application property of the liquid.

As a result of intensive studies, it has been found that by applying a postprocessing liquid in which the polar component of the surface tension (hereinafter, in the present specification, “polar component of the surface tension” may be simply referred to as “polarity”) is controlled, the application property to the fixed image is improved, and the adhesiveness at the time of re-postprocessing also becomes excellent.

Here, in the present invention, the term “re-postprocessing” refers to processing treatments (processing treatments after the first time), such as application of a decorative agent to the fixed image after the above-described postprocessing.

Conventionally, printing materials used for image formation in digital printing often contain wax. As a result, the surface tension of the fixed image decreases due to, for example, the bleeding of the wax to the surface of the image, which makes it difficult to perform postprocessing such as application of a liquid.

Generally, in order to apply a liquid to a fixed image as postprocessing, the surface tension of the liquid needs to be lower than that of the fixed image.

However, there is a limit on the lower limit of the surface tension of the liquid, and it is difficult to lower the surface tension to 20 mN/m or less.

On the other hand, since the surface tension of the image is about 20 to 30 mN/m, assuming that the surface tension of the image is 20 mN/m, it is difficult to set the surface tension of the liquid to be lower than the surface tension of the image.

Therefore, only taking into consideration the surface tensions of the fixed image and the liquid makes the liquid be repelled by the fixed image at the time of application of the liquid.

For the reason(s) described above, it is preferable that the surface tension of the liquid is low, but since the limit thereon is determined to some extent, it is difficult to appropriately secure the above-described application property only by that.

The postprocessing liquid applied to a fixed image forms a layer of the postprocessing liquid on the fixed image. If the surface tension of the postprocessing liquid is low, the surface tension of the layer of postprocessing liquid or a cured film (layer) made by curing the layer of postprocessing liquid also becomes low.

For example, a case where a decorative agent such as a foil is applied as the re-postprocessing will be considered. In this case, it is considered that if the surface tension of the layer of the postprocessing liquid or the cured film obtained by curing the layer of the postprocessing liquid is low as described above, the surface tension of the decorative agent becomes higher than the surface tension of the layer of the postprocessing liquid formed on the fixed image.

Therefore, the adhesiveness of the decorative agent, such as a foil, to be applied as re-postprocessing to the postprocessing liquid or a cured film obtained by curing the postprocessing liquid decreases (re-postprocessing property decreases).

Here, it is known that the application property of the liquid also depends on the polarity of the liquid.

The polarity of the liquid cannot be directly measured, and hence it is indirectly calculated by measuring the interfacial tension of the liquid to water.

As the interfacial tension of the liquid with respect to water is low, the polarity of the liquid is high, and as the interfacial tension of the liquid with respect to water is high, the polarity of the liquid is low.

That is, controlling the polarity of the liquid means controlling the interfacial tension of the liquid with respect to water.

Therefore, it is also possible to use the interfacial tension of the liquid with respect to water as a substitute value for the polarity of the liquid.

When the interfacial tension of the liquid with respect to water is too low (the polarity is too high), the application property of the liquid to a fixed image deteriorates.

It is considered that this is because the hydrophilicity of the surface of the fixed image is low, the liquid having an excessively high polarity becomes less compatible with the surface.

On the other hand, although the cause is not clear, even in the case where the interfacial tension of the liquid with respect to water is too high (the polarity is too low), the application property to the fixed image is slightly deteriorated.

From the above, it can be seen that controlling the interfacial tension of the liquid with respect to water to be within an appropriate range, namely, not to be too low or too high, is important for improving the application property of the liquid with respect to the fixed image.

The liquid applied to the fixed image forms a layer of the liquid on the fixed image, and the surface tension of the layer of the liquid becomes higher than the surface tension of the liquid itself.

The surface tension of the layer of the liquid becomes higher as the interfacial tension of the liquid with respect to water is lower (the polarity is higher).

In particular, when the cured film of the liquid is formed by irradiating the layer of the liquid with ultraviolet rays, the surface tension of the cured film is higher than that of the layer of the liquid.

It is considered that when re-postprocessing is performed, the surface tension of the above-mentioned cured film is required to be 30 mN/m or more in practice. As the surface tension of the cured film is higher, the adhesiveness or adhesion in a case where a foil or a printing material is further placed thereon increases, and the durability of a re-processed product (a product after being subjected to re-postprocessing) also increases.

In order to increase the surface tension of the cured film, the polarity of the liquid needs to be high, that is, the interfacial tension of the liquid needs to be low.

The reason is considered that, if a layer of the liquid is formed by the liquid having a high polarity (low interfacial tension with to respect to water) or a cured film is formed by curing the layer of the liquid, a highly polar component contained in the liquid bleeds to the surface, thereby increasing the surface tension.

Thus, by controlling the interfacial tension of the postprocessing liquid with respect to water to be within an appropriate range, that is, within the range of 2 to 13 mN/m at a temperature of 25° C. in the present invention, it is possible to improve the adhesion during the re-postprocessing while maintaining excellent application property of the postprocessing liquid to the fixed image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic view of an example showing each step of an image forming method of the present invention;

FIG. 2 is a conceptual diagram of a pendant drop in the outside air;

FIG. 3 is a conceptual diagram of a pendant drop in water;

FIG. 4 is a conceptual diagram illustrating a reprocessing step of a fixed image in a hot stamp method;

FIG. 5 is a conceptual diagram illustrating a reprocessing step of a fixed image in a cold foil method;

FIG. 6 is a conceptual diagram illustrating a reprocessing step of a fixed image in a spot varnish+foil method; and

FIG. 7 is a schematic view of an image forming apparatus.

### DETAILED DESCRIPTION

Hereinafter, one or more embodiments of the present disclosure will be described in detail with reference to the drawings. However, the scope of the present invention is not limited to the disclosed embodiments or illustrated examples.

An image forming method of the present invention includes: forming an image with a printing material containing a wax on a recording medium; applying a postprocessing liquid onto the image as postprocessing; and forming a layer of the postprocessing liquid, wherein the interfacial tension of the postprocessing liquid to water is within a range of 2 to 13 mN/m at 25° C.

This feature(s) is a technical feature(s) common to or corresponding to each embodiment (aspect) below.

As an embodiment of the present invention, it is preferable that the surface tension of the postprocessing liquid be within the range of 18 to 25 mN/m at a temperature of 25° C. from the viewpoint of application property in postprocessing to a fixed image.

It is preferable that the postprocessing liquid is a photocurable postprocessing liquid containing an active ray reactive monomer, a polymerization initiator and a silicone-based compound, and the method of curing the layer of the postprocessing liquid is a method of emitting an active ray, from the viewpoint of application property at the time of postprocessing to a fixed image.

The step of forming the image is preferably performed by an electrophotographic method or an inkjet method from the viewpoint of fixability of the image.

The silicone-based compound is preferably dimethylsiloxane having an ethylene oxide group in a side chain from the viewpoint of controlling the surface tension of the postprocessing liquid and the polar component thereof.

It is more preferable that the mole fraction of the ethylene oxide group is within a range of 20 to 50% with respect to the total molar amount of the dimethylsiloxane from the viewpoint of controlling the surface tension and the polar component thereof.

From the viewpoint of controlling the surface tension of the postprocessing liquid and the polar component thereof, it is preferable that the interfacial tension of the active ray reactive monomer with respect to water is in the range of 2 to 20 mN/m at a temperature of 25° C.

It is preferable that the active ray reactive monomer contains a bifunctional active ray reactive monomer having an alkyl group in its main chain in a range of 40 to 80 mass % with respect to the total amount of the postprocessing liquid from the viewpoint of the application property of the postprocessing liquid to a fixed image and the adhesiveness thereof to an image.

Preferably, the surface tension of the image is within a range of 18 to 30 mN/m at 25° C. from the viewpoint of the application property of the postprocessing liquid to the fixed image.

The surface tension of the image is more preferably within a range of 18 to 25 mN/m at a temperature of 25° C. from the viewpoint of the application property of the postprocessing liquid to a fixed image.

The printing material preferably contains a hydrocarbon-based or ester-based wax from the viewpoint of releasability.

From the viewpoint of controlling the surface tension and the polar component thereof, it is preferable that the interfacial tension of the postprocessing liquid to water is within a range of 2 to 10 mN/m at a temperature of 25° C.

From the viewpoint of exhibiting the effects of the present invention, it is preferable to have a step of performing re-postprocessing on the layer of the postprocessing liquid or the cured film of the postprocessing liquid.

The step of forming an image is preferably performed by a roll-to-roll method from the viewpoint of productivity because postprocessing and re-postprocessing can be continuously (in-line) performed.

The thickness of the cured film of the postprocessing liquid is preferably within a range of 1 to 10 mm from the viewpoint of improving the re-postprocessing property.

An image forming system of the present invention includes: an apparatus (or means or device) that forms an image with a printing material containing a wax on a recording medium; an apparatus (or means, device or postprocessing liquid applying apparatus) that applies a postprocessing liquid onto the image as postprocessing; and an apparatus (or means or device) that forms a layer of the postprocessing liquid, wherein the interfacial tension of the postprocessing liquid to water is within a range of 2 to 13 mN/m at 25° C., and is suitably used as a system that carries out the image forming method of the present invention.

The postprocessing liquid of the present invention is characterized in that the interfacial tension to water is within a range of 2 to 13 mN/m at a temperature of 25° C., and is suitably used in the image forming method and the image forming system of the present invention.

The applying apparatus for applying a postprocessing liquid of the present invention is characterized in that a postprocessing liquid is applied onto an image formed with a printing material containing a wax, and is suitably used in the image forming method and the image forming system of the present invention.

Hereinafter, the present invention, components thereof, and modes and aspects for carrying out the present invention will be described in detail. In the present application, “to” is used to mean that numerical values before and after “to” are included as a lower limit value and an upper limit value.

### I. Image Forming Method

The image forming method of the present invention includes: forming an image with a printing material containing a wax on a recording medium; applying a postprocessing liquid onto the image as postprocessing; and forming a layer of the postprocessing liquid, wherein the interfacial tension of the postprocessing liquid to water is within a range of 2 to 13 mN/m at 25° C.

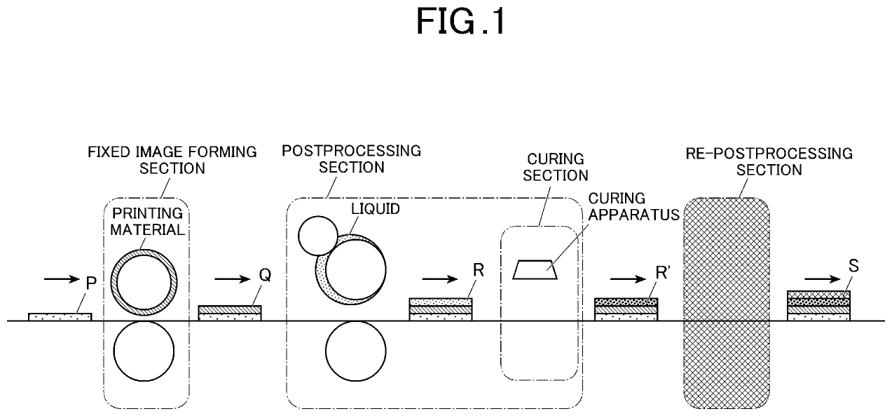

FIG. 1 is a schematic view of an example showing each step of the image forming method of the present invention.

A series of steps by the “fixed image forming section” in FIG. 1 is a “step of forming an image on a recording medium with a printing material containing a wax” according to the present invention. Through the series of steps, a fixed image Q is formed on a recording medium P.

A series of steps by the “postprocessing section” in FIG. 1 is a “step of applying a postprocessing liquid onto an image” and a “step of forming a layer of the postprocessing liquid or a cured film of the postprocessing liquid” according to the present invention. Through the series of steps, a layer R of the postprocessing liquid is formed on the fixed image Q.

The “postprocessing liquid” according to the present invention refers to a postprocessing liquid which is applied onto an image, contains any of a polymerizable monomer, a resin, a polymerization initiator, a solvent, and the like described below, forms a transparent, translucent, or colored coating film (layer), and becomes a cured film (layer) by irradiation with active rays, drying, or the like.

The concept of the “liquid” according to the present invention includes a liquid state having fluidity such as wettability or permeability immediately after the “liquid” is applied onto the fixed image, and a state after that (a state after drying).

The “liquid state having fluidity” refers to a state in which the liquid moves so as to wet-spread or permeate on the fixed image.

The “postprocessing section” is preferably provided with a “curing section” which performs a method of curing the layer R of the postprocessing liquid, and the layer R of the postprocessing liquid is cured in the “curing section” and a cured film R′ of the postprocessing liquid is formed on the fixed image Q.

The curing apparatus installed in the “curing section” is not particularly limited, and examples thereof include a dryer and a light emitter, and the light emitter is preferable from the viewpoint of controlling the degree of curing of the cured film R′ of the postprocessing liquid in the re-postprocessing.

A series of steps in the “re-postprocessing section” in FIG. 1 is a “step of performing re-postprocessing on the layer of the postprocessing liquid or the cured film” according to the present invention.

A re-postprocessed layer S is formed on the layer R of the postprocessing liquid or the cured film R′ of the postprocessing liquid by the series of steps.

As described above, in the present invention, the term “postprocessing” refers to the first processing treatment that is performed on the fixed image, such as application of a postprocessing liquid to the fixed image. The “postprocessing” includes a series of processing treatments on the postprocessing liquid or the layer of the postprocessing liquid, such as drying or curing after application of the postprocessing liquid.

As described above, the “re-postprocessing” refers to processing treatments (processing treatments after the first time) such as application of a decorative agent which is performed after the above-described postprocessing.

### 1. Forming Image with Printing Material Containing Wax on Recording Medium

In the present invention, the printing material used for forming an image on a recording medium contains a wax.

The step of forming an image is preferably performed by an electrophotographic method or an inkjet method from the viewpoint of fixability of the image.

In addition, it is preferable that the step of forming an image is performed by a roll-to-roll method from the viewpoint of productivity because postprocessing and re-postprocessing can be performed continuously (in-line).

### (1.1) Recording Medium

The recording medium used in the image forming method of the present invention is not particularly limited, and examples thereof include plain paper ranging from thin paper to thick paper, high-quality paper, coated printing paper such as art paper or coated paper, water-soluble paper, commercially available Japanese paper or postcard paper, plastic film, cloth, and leather. The recording medium is not limited to the types described above, and the color of the recording medium is not particularly limited.

### (1.2) Printing Material

A printing material according to the present invention contains a wax. The printing material is preferably an electrostatic charge image developing toner, and the electrostatic charge image developing toner contains toner particles containing a binder resin.

In the present invention, the term “toner particles” refers to toner base particles with an external additive added, and an aggregate of toner particles is referred to as “toner”.

In the following description, if it is not particularly necessary to distinguish between “toner base particles” and “toner particles”, they may be simply referred to as “toner particles”.

The toner base particles contain a wax, and may contain other components, such as a charge control agent, if necessary, in addition to the binder resin and the coloring agent.

Hereinafter, as the printing material according to the present invention, first, the wax will be described, and other constituent components (external additive and the like) such as a binder resin, a coloring agent and a charge control agent will be detailed later.

### (Wax)

The wax is not particularly limited, and various known waxes can be used.

Examples thereof include polyolefin waxes such as polyethylene wax and polypropylene wax, branched-chain hydrocarbon waxes such as microcrystalline wax, long-chain hydrocarbon waxes such as paraffin wax and Sasol wax, dialkyl ketone-based waxes such as distearyl ketone, ester waxes such as carnauba wax, montan wax, behenyl behenate, trimethylolpropane tribehenate, pentaerythritol tetrabehenate, pentaerythritol diacetate dibehenate, glycerin tribehenate, 1,18-octadecanediol distearate, tristearyl trimellitate and distearyl maleate, and amide waxes such as ethylenediamine behenyl amide and tristearyl amide trimellitate.

From the viewpoint of releasability, a hydrocarbon-based or ester-based wax is particularly preferable.

The content of the wax is preferably in the range of 1 to 30 parts by mass, and more preferably in the range of 5 to 20 parts by mass, with respect to 100 parts by mass of the binder resin. When the content of the wax is within the above range, sufficient fixing and separating property are obtained.

Examples of the method for introducing the wax into the toner particles include a method in which fine particles composed of only the wax (hereinafter, also referred to as “wax fine particles”) are aggregated and fused in an aqueous medium together with amorphous resin fine particles, crystalline resin fine particles, and the like in the aggregation and fusion step of the method for producing a toner described below.

The wax fine particles can be obtained as a dispersion liquid in which wax is dispersed in an aqueous medium. The dispersion liquid of the wax fine particles can be prepared by heating an aqueous medium containing a surfactant to a temperature equal to or higher than the melting point of the wax, adding a melted wax solution, giving mechanical energy of mechanical stirring or the like or ultrasonic energy, thereby performing fine dispersing, and then performing cooling.

When the amorphous resin is, for example, a styrene-acrylic resin or the like, the wax can be introduced into the toner particles by previously compounding the wax with the amorphous resin fine particles (styrene-acrylic resin fine particles) to be subjected to the aggregation and fusion step.

Specifically, a wax is dissolved in a solution of a polymerizable monomer for forming a styrene-acrylic resin, and this is added to an aqueous medium containing a surfactant.

The dispersion liquid of the amorphous resin fine particles containing a wax can be prepared by a method of adding a polymerization initiator and performing polymerization at a desired polymerization temperature after giving mechanical energy of mechanical stirring or the like or ultrasonic energy in the same manner as described above. This method is a so-called mini-emulsion polymerization method.

The wax tends to appear on the surface of the image during fixing of the toner and has an adverse effect of reducing the surface tension of the image.

The present invention is characterized in that even in an image having a decreased surface tension as described above, the adverse effect on postprocessing property according to the present invention can be removed.

### (1.3) Image

An image according to the present invention is formed on a recording medium with a printing material containing wax. The method of forming an image is not particularly limited, but is preferably performed by a roll-to-roll method from the viewpoint of productivity since postprocessing and re-postprocessing can be performed continuously (in-line).

### (1.3.1) Surface Tension of Image

Preferably, the surface tension of the image is within a range of 18 to 30 mN/m, more preferably a range of 18 to 25 mN/m, at 25° C. from the viewpoint of the application property of the postprocessing liquid to the fixed image.

### Method for Calculating Surface Tension of Image

The surface tension (γs) of the image according to the present invention is calculated as follows. First, a liquid drop is added onto the surface of the image. and a contact angle θ of the liquid drop is measured with a fully automatic contact angle meter “Dmo-702” manufactured by Kyowa Interface Science Co., Ltd. Then, by using the following <Kitazaki and Hata's Theory Formula>. three simultaneous equations are established from the following three kinds of liquids. where the values of the surface tension γ_{L} at room temperature of 25° C., and the dispersion component γ^{d}, polar component γ^{p} and hydrogen bond component γ^{h} are known as shown in Table I. The surface tension of an image is calculated by solving these. The amount of the liquid drop at the time of measurement was 1 to 3 μL.

### Liquid

Water
Diiodomethane
Hexadecane

γ^{total}=γ^{d}+γ^{p}+γ^{h}

W_{SL}=2\sqrt{γ_{S}^{d}γ_{L}^{d}}+2\sqrt{γ_{S}^{p}γ_{L}^{p}}+2\sqrt{γ_{S}^{h}γ_{L}^{h}}

\sqrt{γ_{S}^{d}γ_{L}^{d}}+\sqrt{γ_{S}^{p}γ_{L}^{p}}+\sqrt{γ_{S}^{h}γ_{L}^{h}}=γ_{L}^{total}(1+cos θ)/2 [Math. 1]

In the above formulae, γ^{total} is the total surface tension into which the dispersion component γ^{d}, the polar component γ^{p} and the hydrogen bond component γ^{h} of the surface tension are combined, and γ_{L}^{total} is the total surface tension of the liquid.

W_{SL} is an adhesive work, and the adhesive work W_{SL} is expressed by the following formula (W_{SL}).

Formula (W_{SL})

W_{SL}=γ_{L}(1+COS θ)

The other symbols represent as follows.
γ_{S}^{d}: Dispersion component of surface tension of solid (image)
γ_{L}^{d}: Dispersion component of surface tension of liquid
γ_{S}^{p}: Polar component of surface tension of solid (image)
γ_{L}^{p}: Polar component of surface tension of liquid
γ_{S}^{h}: Hydrogen bond component of surface tension of solid (image)
γ_{L}^{h}: Hydrogen bond component of surface tension of liquid

TABLE I

| TYPE OF LIQUID | | | HYDROGEN | |
|---|---|---|---|---|
| USED FOR | DISPERSION | POLAR | BOND | SURFACE |
| CALCULATION OF | COMPONENT | COMPONENT | COMPONENT | TENSION |
| SURFACE TENSION | γ_{L}^{d} | γ_{L}^{p} | γ_{L}^{h} | γ_{L}^{total} |
| OF IMAGE | [mN/m] | [mN/m] | [mN/m] | [mN/m] |
| WATER | 29.1 | 1.3 | 42.4 | 72.8 |
| DIIODOMETHANE | 46.8 | 4.0 | 0.0 | 50.8 |
| HEXADECANE | 27.6 | 0.0 | 0.0 | 27.6 |

### (1.3.2) Interfacial Tension of Image to Water

### Method for Calculating Interfacial Tension of Image to Water

The interfacial tension of the image with respect to water (γ_{SL}) can be calculated by the following Young's formula using the contact angle θ of a liquid drop on the surface of the image measured by a fully automatic contact angle met“r “Dmo-”02” manufactured by Kyowa Interface Science Co., Ltd., the calculated surface tension of the image (γ_{S}), and the surface tension of the postprocessing liquid (γ_{L}) calculated by a measurement method described later.

γ_{S}=γ_{L}·COS θ+γ_{SL} Young's Formula

### 2. Step of Applying Postprocessing Liquid on Image

Onto the image formed with the printing material containing wax on the recording medium according to the present invention, the postprocessing liquid is applied as postprocessing.

The method for applying the postprocessing liquid is not particularly limited, and examples thereof include a roll coating method, an inkjet method, and a spraying method, and a roll coating method is preferable.

In the present invention, the “roll coating” is defined in JIS K 5500 as a method in which a flat object is made to pass between two or more horizontally-placed hard rolls (also referred to as “rollers”) to apply an application liquid (e.g., coating).

### 3. Step of Forming Layer of Postprocessing Liquid

It is preferable that the layer of the postprocessing liquid according to the present invention is cured by being irradiated with light using a photocurable postprocessing liquid as the postprocessing liquid to form a cured film of the postprocessing liquid.

The concept of the “liquid” according to the present invention includes a liquid state having fluidity such as wettability or permeability immediately after the “liquid” is applied onto the fixed image, and a state after that (a state after drying).

The “liquid state having fluidity” refers to a state in which the liquid moves so as to wet-spread or permeate on the fixed image.

Examples of the light include ultraviolet rays, and the cured film of the postprocessing liquid formed by irradiation with the ultraviolet rays has a surface tension of 30 mN/m or more.

The thickness of the cured film of the postprocessing liquid is preferably within a range of 1 to 10 mm from the viewpoint of improving the re-postprocessing property.

In the present invention, since the application property of the postprocessing liquid is improved, the postprocessing liquid can be sufficiently applied even to a thin layer (for example, the above-described 1 to 10 mm) that cannot be applied to a normal digital image.

### (3.1) Postprocessing Liquid

The “postprocessing liquid” according to the present invention is a postprocessing liquid to be applied onto an image. It refers to the one that contains any of the below-described polymerization monomer, resin, polymerization initiator, solvent and the like, forms a transparent, semitransparent or colored coating film (layer) and becomes a cured film (layer) by irradiation with active rays, drying or the like. For example, the “varnish” corresponds to the postprocessing liquid.

In particular, the postprocessing liquid of the present invention is characterized in that the interfacial tension of the postprocessing liquid to water is within a range of 2 to 13 mN/m at a temperature of 25° C.

### (3.1.1) Surface Tension of Postprocessing Liquid

The surface tension of the postprocessing liquid is adjusted to 30 mN/m or less at a temperature of 25° C. When this surface tension is more than 30 mN/m, there is a concern that an image containing a wax and having a low surface tension (surface tension of 30 mN/m or less) cannot be coated.

As an embodiment of the present invention, it is preferable that the surface tension of the postprocessing liquid be within a range of 18 to 25 mN/m at a temperature of 25° C. from the viewpoint of application property to a fixed image that has been postprocessed.

### Method for Calculating Surface Tension of Postprocessing Liquid

The surface tension of the postprocessing liquid according to the present invention can be calculated as follows. First, a fully automatic contact angle meter “DMo-702” (manufactured by Kyowa Interface Science Co., Ltd) is set to a pendant drop method mode, and a postprocessing liquid is dropped from the tip of a thin tube (injection needle) installed vertically. Then, the shape of the largest pendant drop (drop) that does not fall is measured, and the ds/de method is used for calculation. Note that at that time. the calculation is performed by using the surface tension's relational expression (A).

Since the pendant drop formed at the tip of the thin tube depends on the amount of the liquid, the density difference and the surface/interfacial tension, the surface tension can be calculated by analyzing the shape of the pendant drop.

Further, it is possible to measure not only the liquid-gas surface tension but also the interfacial tension of the postprocessing liquid to water according to the present invention by discharging different liquid drops from the tip of the thin tube (injection needle) in a liquid tank filled with water.

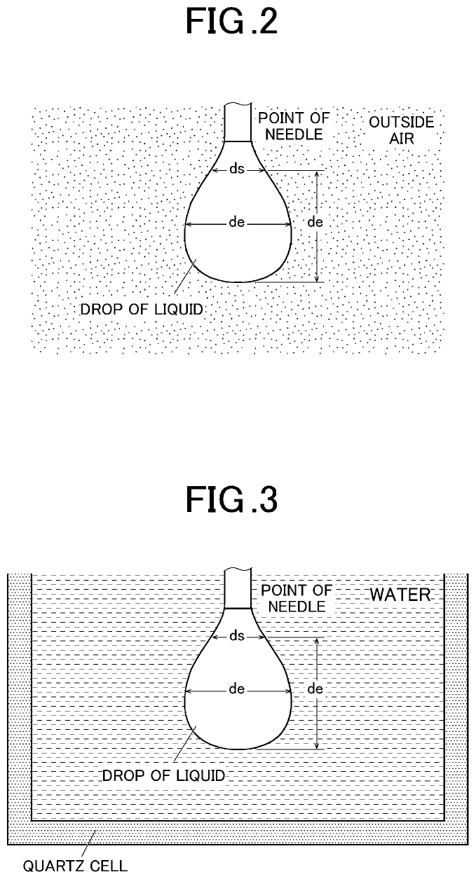

FIG. 2 is a conceptual diagram of a pendant drop in the outside air.

Surface Tension's Relational Expression (A)

γ=Δρg(de)²(1/H)

The symbols in the above expression are as follows.

Note that de, ds and the correction coefficient (1/H) are automatically calculated by setting the mode of the pendant drop method of the fully automatic contact angle meter “DMo-702” ds/de.

In the present invention, the value of the density difference Δρ between the postprocessing liquid and water is calculated by setting the specific gravity of water as 1 g/cm³.
γ: Surface Tension
Δρ: Density Difference between postprocessing Liquid and Water
g: Gravitational Acceleration
de: Maximum Diameter of Pendant Drop (Shown in FIG. 2)
ds: Diameter of Pendant Drop at Level of de from Lower End of Pendant Drop (Shown in FIG. 2)
(1/H): Correction Coefficient based on ds/de

The calculation procedure is as described in the following (1) to (7).

(1) A fully automatic contact angle meter “DMo-702” (manufactured by Kyowa Interface Science Co., Ltd) is set to a pendant drop method mode.

(2) The postprocessing liquid is put into a thin tube needle (injection needle) for measurement installed vertically and set in the fully automatic contact angle meter “DMo-702” (manufactured by Kyowa Interface Science Co., Ltd).

(3) The postprocessing liquid is dropped from the thin tube needle (injection needle) to form the largest pendant drop that does not fall.

(4) An image of the pendant drop is taken by a CCD camera, and the shape of the pendant drop is measured.

(5) The surface tension y of the postprocessing liquid is obtained by substituting the respective values into the aforementioned surface tension's relational expression (A).

### (3.1.2) Interfacial Tension of Postprocessing Liquid to Water

In the present invention, in order to improve the adhesiveness at the time of re-postprocessing while maintaining the excellent application property of the postprocessing liquid to a fixed image, the interfacial tension of the postprocessing liquid with respect to water is in a range of 2 to 13 mN/m.

If the interfacial tension of the postprocessing liquid with respect to water is less than 2 mN/m, the polar component of the surface tension of the postprocessing liquid (hereinafter, the polar component of the surface tension may be simply referred to as “polarity”) becomes high, and therefore the application property to an image having a low polarity deteriorates.

If the interfacial tension of the postprocessing liquid with respect to water exceeds 13 mN/m, the polarity of the postprocessing liquid becomes low, and therefore the re-postprocessing property deteriorates. Further, the application property to an image also tends to deteriorate.

From the viewpoint of controlling the surface tension and the polar component thereof, it is preferable that the interfacial tension of the postprocessing liquid to water is within a range of 2 to 10 mN/m at a temperature of 25° C.

### Method for Calculating Interfacial Tension of Postprocessing Liquid to Water

The interfacial tension of the postprocessing liquid to water according to the present invention can be calculated in the same manner as described under the “Method for Calculating Surface Tension of postprocessing Liquid”. Specifically, a fully automatic contact angle meter “DMo-702” (manufactured by Kyowa Interface Science Co., Ltd) is set to a pendant drop method mode. Then, as shown in FIG. 3, the postprocessing liquid is dropped into water filled in a quartz cell container from the tip of a thin tube (injection needle) installed vertically. Then, the shape of the largest pendant drop (drop) that can maintain the shape is measured, and the ds/de method is used for calculation.

FIG. 3 is a conceptual view of a pendant drop in water.

The symbols shown in FIG. 3 are as described above.

The calculation procedure is as described in the following (1) to (7).

(1) A fully automatic contact angle meter “DMo-702” (manufactured by Kyowa Interface Science Co., Ltd) is set to a pendant drop method mode.

(2) Water is placed in a quartz cell.

(3) The postprocessing liquid is put into a thin tube needle (injection needle) for measurement installed vertically and set in the fully automatic contact angle meter “DMo-702” (manufactured by Kyowa Interface Science Co., Ltd).

(4) The thin tube needle (injection needle) is immersed in water.

(5) The postprocessing liquid is dropped into water from the thin tube needle (injection needle) to form the largest pendant drop that can maintain the shape.

(6) An image of the pendant drop is taken by a CCD camera, and the shape of the pendant drop is measured.

(7) The interfacial tension of the postprocessing liquid to water is obtained by substituting the respective values into the aforementioned surface tension's relational expression (A).

### (3.1.3) Contained Substances of Postprocessing Liquid

It is preferable that the postprocessing liquid is a photocurable postprocessing liquid containing an active ray reactive monomer, a silicone-based compound, and a polymerization initiator, and the method for curing the layer of the postprocessing liquid is a method of irradiating the layer with active rays, from the viewpoint of application property at the time of postprocessing on a fixed image.

Further, it is preferable from the viewpoint of effect expression that the photocurable postprocessing liquid is a UV-curable resin solution (which may be referred to as “varnish” in this specification).

In order to control the surface tension and the interfacial tension to water, selection of the active ray reactive monomer and the silicone-based compound that are the constituents of the photocurable postprocessing liquid is particularly important.

### Active Ray Reactive Monomer

The active ray reactive monomer is a compound that is cured by irradiation with active energy rays (which may be simply referred to as “active rays”), such as ultraviolet rays, visible light rays, and electron beams, and does not correspond to either the photo polymerization initiator or the pigment dispersant described below. Hereafter, the “active ray reactive monomer” may be simply referred to as a “reactive monomer”.

The active ray reactive monomer is preferably an unsaturated carboxylic acid ester compound, and more preferably (meth)acrylate.

Examples of the (meth)acrylate include bifunctional (meth)acrylates such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,10-decanediol di(meth)acrylate, 1,9-nonanediol di(meth)acrylate, neopentyl glycol di(meth)acrylate, dimethylol-tricyclodecane di(meth)acrylate, hydroxypivalic acid neopentyl glycol di(meth)acrylate, polytetramethylene glycol di(meth)acrylate, polyethylene glycol diacrylate and tripropylene glycol diacrylate; and trifunctional or more polyfunctional (meth)acrylates such as trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerin propoxy tri(meth)acrylate and pentaerythritol ethoxy tetra(meth)acrylate.

The (meth)acrylate may be a modified product, and examples thereof include alkylene oxide-modified (meth)acrylates such as ethylene oxide-modified (meth)acrylates such as ethylene oxide-modified trimethylolpropane tri(meth)acrylate and ethylene oxide-modified pentaerythritol tetraacrylate, and propylene oxide-modified (meth)acrylates such as propylene oxide-modified trimethylolpropane triacrylate; caprolactone-modified (meth)acrylates such as caprolactone-modified trimethylolpropane tri(meth)acrylate; and caprolactam-modified (meth)acrylates such as caprolactam-modified dipentaerythritol hexa(meth)acrylate.

Among these, alkylene oxide-modified (meth)acrylate is preferable.

Since the active ray reactive monomer is a main component of the postprocessing liquid and the content thereof is 50% or more of the entire postprocessing liquid, the polarity of the active ray reactive monomer itself affects the polarity of the postprocessing liquid.

In particular, since a bifunctional active ray reactive monomer is a main component of the active ray reactive monomer, it is necessary to control the polarity (interfacial tension to respect to water) of the bifunctional active ray reactive monomer.

If the ratio of a tri- or more functional active ray reactive monomer is increased, the viscosity of the liquid is improved.

The liquid viscosity can be adjusted by using the ratio of the bifunctional active ray reactive monomer and the tri- or more functional active ray reactive monomer.

At the time, for adjustment of the viscosity, a diluent such as vinyl pyrrolidone or acryloyl monofolin may be used.

In the present invention, the “bifunctional active ray reactive monomer” refers to an active ray reactive monomer having two functional groups, and tee “tri- or more functional active ray reactive monomer” refers to an active ray reactive monomer having three or more functional groups.

The interfacial tension of the bifunctional active ray reactive monomer as a main component with respect to water needs to be 2 mN/m or more. If it is less than 2 mN/m, the polarity is too large, and the application property of the postprocessing liquid to a fixed image deteriorates.

### Content of Active Ray Reactive Monomer

It is preferable that the active ray reactive monomer contains a bifunctional active ray reactive monomer having an alkyl group in its main chain within a range of 40 to 80 mass % with respect to the total amount of the postprocessing liquid from the viewpoint of the application property of the postprocessing liquid to a fixed image and the adhesiveness thereof to an image.

It is preferable that the content of the bifunctional active ray reactive monomer is 40% or more and the content of the tri- or more functional active ray reactive monomer is less than 60%. If the content of the tri- or more functional active ray reactive monomer is 80% or more, the application property of the postprocessing liquid may deteriorate, or the curing speed may be too high and cause curing shrinkage, resulting in impairing of the adhesiveness of the postprocessing liquid to an image.

### Interfacial Tension of Active Ray Reactive Monomer to Water

From the viewpoint of controlling the surface tension of the postprocessing liquid and the polar component thereof, it is preferable that the interfacial tension of the active ray reactive monomer with respect to water is in the range of 2 to 20 mN/m at a temperature of 25° C.

The interfacial tension of the active ray reactive monomer to water can be calculated by using the active ray reactive monomer instead of the postprocessing liquid in the method for measuring the interfacial tension of the postprocessing liquid to water described above.

If the interfacial tension is less than 2 mN/m, the polarity is too large, and the application property of the postprocessing liquid to an image deteriorates.

Examples of the bifunctional active ray reactive monomer having an interfacial tension to water of 2 mN/m or more include, but are not limited to, 1,4-butanediol di(meth)acrylate, 1,6-hexanediol di(meth)acrylate, 1,9-nonanediol di(meth)acrylate, 1,10-decanediol di(meth)acrylate, and neopentyl glycol di(meth)acrylate.

In particular, 1,6-hexanediol di(meth)acrylate and 1,9-nonanediol di(meth)acrylate each of which has straight-chain hydrocarbon as a main skeleton, are preferable.

In order to increase the curing speed, a tri- or more functional active ray reactive monomer may be contained. Examples of the tri- or more functional active ray reactive monomer include, but are not limited to, trimethylolpropane triallylate and pentaerythritol tetra(meth)acrylate.

The (meth)acrylate may be a modified product, and examples thereof include alkylene oxide-modified (meth)acrylate and caprolactone-modified (meth)acrylate.

Calculation results of the interfacial tension of the active ray reactive monomer to water include, for example, those in the following Table II.

TABLE II

| | | INTERFACIAL | |
|---|---|---|---|
| | | TENSION | |
| ACTIVE RAY REACTIVE MONOMER | | TO WATER | |
| ABBREVIATION | NAME | [mN/m] | REMARKS |
| HDDA | 1,6-HEXANEDIOL DIACRYLATE | 8.8 | BIFUNCTIONAL |
| PEGDA | POLYETHYLENE GLYCOL DIACRYLATE | 1.2 | BIFUNCTIONAL |
| TMPTA | TRIMETHYLOLPROPANE TRIACRYLATE | 12.9 | TRIFUNCTIONAL |
| TMPTA- | ETHOXYLATED TRIMETHYLOLPROPANE | 9.1 | TRIFUNCTIONAL |
| 3E0 | TRIACRYLATE | | |
| PETA | PENTAERYTHRITOL TETRAACRYLATE | 7.7 | TRIFUNCTIONAL |

The chemical structural formulae of the active ray reactive monomers shown in Table II are as follows.

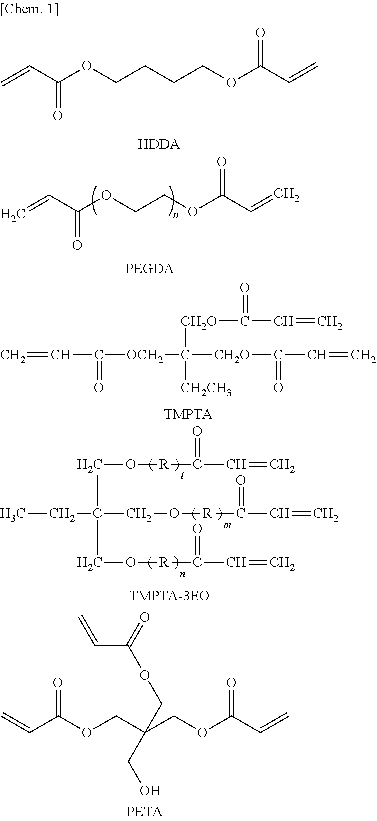

### Silicone-Based Compound

The silicone-based compound according to the present invention greatly affects the surface tension and the polarity (interfacial tension to water) of the postprocessing liquid.

The content of the silicone-based compound (dimethylsiloxane) according to the present invention is preferably in a range of 0.01 to 10 mass % with respect to the total amount of the postprocessing liquid.

The silicone-based compound is preferably dimethylsiloxane having an ethylene oxide group in a side chain from the viewpoint of controlling the surface tension of the postprocessing liquid and the polar component thereof.

It is more preferable that the mole fraction of the ethylene oxide group is within a range of 20 to 50% with respect to the total molar amount of the dimethylsiloxane from the viewpoint of controlling the surface tension and the polar component thereof.

The structure of polyether-modified dimethylsiloxane (which may be simply referred to “s “dimethylsiloxane”) is shown below. This polyether-modified dimethylsiloxane affects the surface tension of the postprocessing liquid and the polarity (interfacial tension to water) greatest.

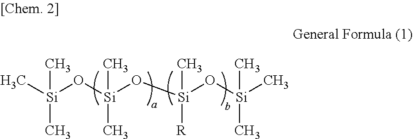

R represents a substituent having an ethylene oxide (EO) group [—(CH₂CH₂O)—]. R may contain a propylene oxide (PO) group, an alkyl group, an aromatic ring or an acrylic group.

### Percentage of Silicone-Based Compound in Total Amount of Postprocessing Liquid

It is preferable to add the silicone-based compound within a range of 0.01 to 10% by mass, preferably within a range of 0.2 to 2% by mass, relative to the total amount of the postprocessing liquid, from the viewpoint of exhibiting the effects of the present invention.

If the content is less than 0.01%, the surface tension of the postprocessing liquid does not sufficiently decrease, and the application property of the postprocessing liquid to a fixed image deteriorates. The upper limit of the silicone-based compound to be added to the postprocessing liquid is not strictly set. However, if it is more than 10%, there is a concern that it may adversely affect the film characteristics after film formation, for example, the film strength is weakened. Even if a predetermined amount or more thereof is added, the action of reducing the surface tension is not improved.

### Mole Fraction of Ethylene Oxide Group

It is preferable that the mole fraction of the ethylene oxide group is within a range of 20 to 50% with respect to the total molar amount of dimethylsiloxane from the viewpoint of suppressing decrease in the hydrophilicity of the postprocessing liquid and suppressing excessive increase in the interfacial tension of the postprocessing liquid with respect to water.

In the case of less than 20%, there is a concern that the hydrophilicity of the postprocessing liquid decreases, and the interfacial tension with to respect to water becomes 13 mN/m or more.

In the case of more than 50%, there is a concern that the hydrophilicity of the postprocessing liquid increases, and the interfacial tension with to respect to water becomes less than 2 mN/m.

### Method for Calculating Mole Fraction of Ethylene Oxide Group

The mole fraction of the ethylene oxide group to the total molar amount of the dimethylsiloxane according to the present invention can be calculated by the following procedure after measuring the ¹H-NMR (nuclear magnetic resonance) spectrum with a nuclear magnetic resonance apparatus “JOEL ECZ400” (400 MHZ, manufactured by JEOL Ltd).

In order to use the layer of the postprocessing liquid or the cured film of the postprocessing liquid as a measurement sample, first, the layer of the postprocessing liquid or the cured film of the postprocessing liquid formed on the fixed image is cut from the fixed image with a cutter or the like, and a specimen thereof is dissolved in chloroform (CHCl₃).

When the main component of the postprocessing liquid is an active ray reactive monomer, since a cured product of the active ray reactive monomer is not dissolved in the chloroform, the dissolved product is a silicone-based compound (dimethylsiloxane).

The above-mentioned dissolved product is dried, and then dissolved in a measurement solvent (deuterated chloroform: CDCl₃). The 1H-NMR spectrum is measured with 7.25 ppm chloroform in deuterated chloroform as an internal standard, and the ethylene oxide group in the dimethylsiloxane, the side chain methyl group of the propylene oxide group unit, and the dimethylsilane are identified.

Chemical shifts (peaks) specific to an ethylene oxide group, a side chain methyl group of a propylene oxide group unit, and dimethylsilane are shown below.

Ethylene Oxide Group: around 3.0 to 4.2 ppm

Side Chain Methyl Group of Propylene Oxide Group Unit: around 0.7 to 1.3 ppm

Dimethylsilane: around 0.4 to 0.2 ppm

As described above, the one having a characteristic chemical shift (peak) within a certain range can be distinguished from other chemical structures.

The spectrum is measured by ¹H-NMR (nuclear magnetic resonance), and the integral values obtained from the ranges having the respective chemical shifts (peaks) are substituted into the following formula(e) to calculate the mole fraction of the ethylene oxide group to the total molar amount of the dimethylsiloxane.

(Mole Fraction of Ethylene Oxide Group to Total Molar Amount of Dimethylsiloxane [mol %])=Molar Amount of Ethylene Oxide Group [mol]/[(Molar Amount of Ethylene Oxide Group [mol])+(Molar Amount of Propylene Oxide Group [mol])+(Molar Amount of Dimethylsilane [mol]) (Formula)

The molar amount [mol] of the ethylene oxide group, the molar amount [mol] of the propylene oxide group, and the molar amount [mol] of the dimethylsilane in the above formula are obtained from formulae (a), (b) and (c) below.

Molar Amount of Ethylene Oxide Group [mol]=(A−B)/4 Formula (a)

Molar Amount of Propylene Oxide Group (mol)=B/3 Formula (b)

Molar Amount of Dimethylsilane (mol)=C/6 Formula (c)

The A, B and C in the above formulae (a), (b) and (c) are as follows.

A: Integral Value in Range of Chemical Shift (Peak) 3.0 to 4.2 ppm Specific to Ethylene Oxide Group

B: Integral Value in Range of Chemical Shift (Peak) 0.7 to 1.3 ppm Specific to Side Chain Methyl Group of Propylene Oxide Group Unit

C: Integral Value in Range of Chemical Shift (Peak) −0.4 to 0.2 ppm Specific to Dimethylsilane

### Polymerization Initiator

The polymerization initiator includes a radical polymerization initiator when the active ray curable compound is a compound having a radically polymerizable functional group, and includes a photoacid generator when the active ray curable compound is a compound having a cationically polymerizable functional group.

The content of the polymerization initiator is preferably within a range of 1 to 20% with respect to the total amount of the postprocessing liquid according to the present invention.

The polymerization initiator may be a combination of both a radical polymerization initiator and a photoacid generator.

The radical polymerization initiator includes a cleavage type radical polymerization initiator and a hydrogen abstraction type radical polymerization initiator.

Examples of the cleavage-type radical polymerization initiator include acetophenone-based initiators such as diethoxyacetophenone, 2-hydroxy-2-methyl-1-phenylpropan-1-one, benzyldimethylketal, 1-(4-isopropylphenyl)-2-hydroxy-2-methylpropan-1-one, 4-(2-hydroxyethoxy) phenyl-(2-hydroxy-2-propyl) ketone, 1-hydroxycyclohexyl-phenyl ketone, 2-methyl-2-morpholino (4-thiomethylphenyl) propan-1-one and 2-benzyl-2-dimethylamino-1-(4-morpholinophenyl)-butanone; benzoin-based initiators such as benzoin, benzoin methyl ether and benzoin isopropyl ether; acylphosphine oxide-based initiators such as 2,4,6-trimethylbenzoin diphenylphosphine oxide; benzil; and methylphenylglyoxy ester.

Examples of the hydrogen abstraction type radical polymerization initiator include benzophenone-based initiators such as benzophenone, methyl 2-benzoylbenzoate, 4-phenylbenzophenone, 4,4′-dichlorobenzophenone, hydroxybenzophenone, 4-benzoyl-4′-methyl-diphenyl sulfide, acrylated benzophenone,3,3′,4,4′-tetra(t-butylperoxycarbonyl) benzophenone and 3,3′-dimethyl-4-methoxybenzophenone; thioxanthone-based initiators such as 2-isopropyl thioxanthone, 2,4-dimethyl thioxanthone, 2,4-diethyl thioxanthone and 2,4-dichlorothioxanthone; aminobenzophenone-based initiators such as Michler's ketone and 4,4′-diethylaminobenzophenone: 10-butyl-2-chloroacridone, 2-ethylanthraquinone, 9,10-phenanthrenequinone and camphorquinone.

Examples of the photoacid generator include triarylsulfonium hexafluorophosphate salts, iodonium (4-methylphenyl) (4-(2-methylpropyl) phenyl) hexafluorophosphate, triarylsulfonium hexafluoroantimonate, and 3-methyl-2-butenyltetramethylene sulfonium hexafluoroantimonate.

The content of the polymerization initiator is preferably in a range of 0.1 to 10% by mass and more preferably in a range of 2 to 8% by mass with respect to the total mass of the postprocessing liquid.

### Another Polymer

As another polymer, an acrylic polymer is suitable. Such another polymer can improve the adhesiveness to an image, adjust the curing speed, and adjust the viscosity of the postprocessing liquid.

When an acrylic polymer is contained in the postprocessing liquid according to the present invention, the above-described acrylic polymer is dissolved in the reactive monomer.

The acrylic polymer is obtained by polymerizing any of the following monomers, but is not limited thereto.

Examples of the (meth)acrylate ester monomer include methyl (meth)acrylate, ethyl (meth)acrylate, N-butyl (meth)acrylate, isopropyl (meth)acrylate, isobutyl (meth)acrylate, t-butyl (meth)acrylate, N-octyl (meth)acrylate, 2-ethylhexyl (meth)acrylate, stearyl (meth)acrylate, lauryl (meth)acrylate, phenyl (meth)acrylate, diethylaminoethyl (meth)acrylate, dimethylaminoethyl (meth)acrylate, and derivatives thereof.

In the acrylic polymer, styrene may be copolymerized. In the case where styrene is copolymerized, the copolymerization percentage of styrene is preferably 90% or less.

The molecular weight Mw of the acrylic polymer is preferably within a range of 3,000 to 40,000.

The ratio of the acrylic polymer to the postprocessing liquid is preferably within a range of 5 to 20% by mass. In the case where the content is less than 5% by mass, the effect of improving the application property and the adhesiveness decreases, and in the case where the content exceeds 20% by mass, the viscosity of the postprocessing liquid is too high, which may cause a quality problem such as streaks.

### Surface Tension Adjuster

A petroleum-based surfactant or a fluorine-based surfactant may be added in order to adjust the surface tension. As the petroleum-based or fluorine-based surfactant, an anionic or nonionic surfactant is suitable. Furthermore, in order to provide roughness, organic/inorganic fine particles may be added.

### 4. Step of Forming Cured Film of Postprocessing Liquid by Method for Curing Layer of Postprocessing Liquid

It is preferable that the postprocessing liquid is a photocurable postprocessing liquid containing an active ray reactive monomer, a silicone-based compound, and a polymerization initiator, and the method for curing the layer of the postprocessing liquid is a method of irradiating the layer with active rays, from the viewpoint of application property at the time of postprocessing on a fixed image.

It is preferable that the layer of the postprocessing liquid according to the present invention is cured by being irradiated with light using a photocurable postprocessing liquid as the postprocessing liquid to form a cured film of the postprocessing liquid.

### 5. Step of Performing Re-Postprocessing on Layer of Postprocessing Liquid or Cured Film of Postprocessing Liquid

As described above, in the present specification, the term “re-postprocessing” refers to a processing treatment (processing treatment(s) after the first time), such as application of a decorative agent, which is performed after the postprocessing.

The term “re-postprocessed layer” refers to a layer formed by the re-postprocessing on the layer of the postprocessing liquid or the cured film of the postprocessing liquid.

In the postprocessing liquid according to the present invention, by controlling the polarity thereof, that is, the interfacial tension of the postprocessing liquid with respect to water, the surface tension of a cured film of the postprocessing liquid is controlled so as to be higher than that of a re-postprocessed layer which has been subjected to the re-postprocessing (e.g., application of a foil as a decorative agent).

As a result, not only the application property of the postprocessing liquid to the fixed image is improved, but also the adhesiveness to the re-postprocessed layer is improved.

Three examples of the re-postprocessing are given below, but the present invention is not limited thereto.

(1) A method in which a decorative agent such as a foil is pressed and applied by hot stamping onto a fixed image with a layer of a postprocessing liquid formed (which hereinafter may be simply referred to as “hot stamping method”).

(2) A method in which a cold foil is applied using a glue without using “heat” or pressure” onto a fixed image with a layer of a postprocessing liquid formed (which hereinafter may be simply referred as “cold foil method”).

(3) A method in which, like spot varnish+foil processing, without using a plate, a thick varnish pattern is formed on a fixed image with a layer of a postprocessing liquid formed, and a foil is placed and pressed thereon, thereby providing a decorative agent (which hereinafter may be simply referred to as “spot varnish+foil method”).

### Decorative Agent

The decorative material can be appropriately selected depending on the required final image. Various powders can be used, for example, powder or foil having metallic luster in the case of a metallic image, glass flakes or glass beads to change the texture of an image, a phosphorescent pigment in the case of a phosphorescent image, and a thermally expandable microcapsule in the case of an embossed image.

### (5.1) Hot Stamp Method

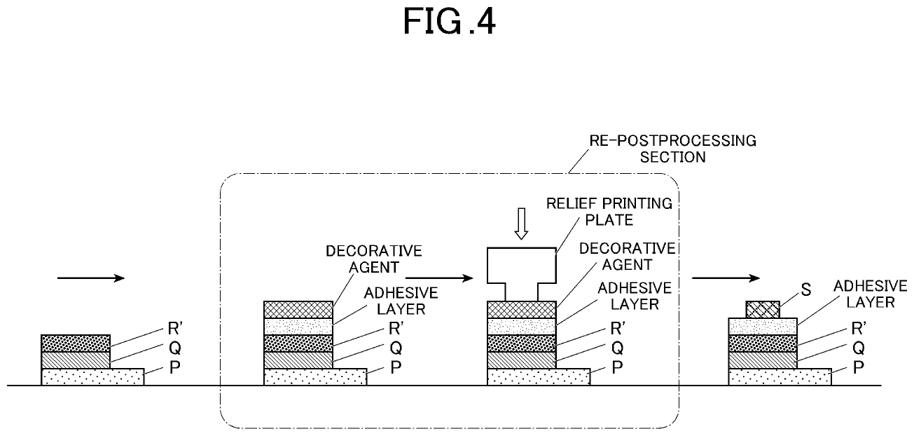

FIG. 4 is a conceptual diagram illustrating a reprocessing step of a fixed image in a hot stamp method. FIG. 4 shows only the steps after the postprocessing section in FIG. 1.

The processing by the hot stamp method is a thermal transfer technology in which a hot stamp foil produced by forming a coating layer of a metal or the like is used to transfer a metallic character, pattern or the like to a non-transfer object by application of pressure and heat.

The above-described processing is a processing method in which re-postprocessing is performed on the fixed image with the layer of the postprocessing liquid formed as if a stamp is pressed thereon, namely, the foil is pressure-bended by heat and pressure.

As an advantage of the hot stamp method, a gold foil or a silver foil can be bonded, and thus an air of luxuriousness can be given, and printing can be performed on a part of a flat surface or a curved surface, or on a material such as leather that is difficult for normal printing to be performed.

Processing steps of the hot stamp method are as follows.

In the curing apparatus included in the curing section of the above-described postprocessing section, the layer R of the postprocessing liquid (UV varnish) is irradiated with ultraviolet rays, so that the cured film R′ of the postprocessing liquid (UV varnish) solidifies.

In the present specification, the “UV varnish” refers to an ultraviolet curable resin liquid, and hereinafter, the “UV varnish” may be simply referred to as “varnish”.

Hereinafter, a hot stamp method in a case where a metal foil is used as the decorative agent will be described as an example. First, a plate (stamp) of a pattern of a metal foil to be placed is prepared.

After that, in the re-postprocessing section, a decorative material having a lower surface to which a hot-melt adhesive (for example, a metal foil having a lower surface to which a hot-melt adhesive is attached) is applied to the cured film R′ of the postprocessing liquid (UV varnish) in the solid state, so that the decorative agent is temporarily adhered.

The decorative agent is pressed against the cured film R′ of the postprocessing liquid (UV varnish) in the solid state with a heated stamp (plate) in the re-postprocessing section by heat and pressure, so that the adhesive on the lower surface of the decorative agent (metal foil) is melted and the decorative agent (metal foil) and the cured film R′ are bonded together.

After that, since the temperature of the bonding portion returns to room temperature, the adhesive is

solidified and the adhesiveness is maintained. Note that the decorative agent (metal foil) in a portion not pressed by the stamp (plate) is not transferred onto the cured film R′.

### (5.2) Cold Foil Method

In the present invention, the processing by the cold foil method is a processing technique in which a dedicated adhesive (paste) is printed by a printing machine on a fixed image with a cured film of a postprocessing liquid formed, a foil is pressed onto the adhesive (paste) for transfer, and then an unnecessary portion is peeled off.

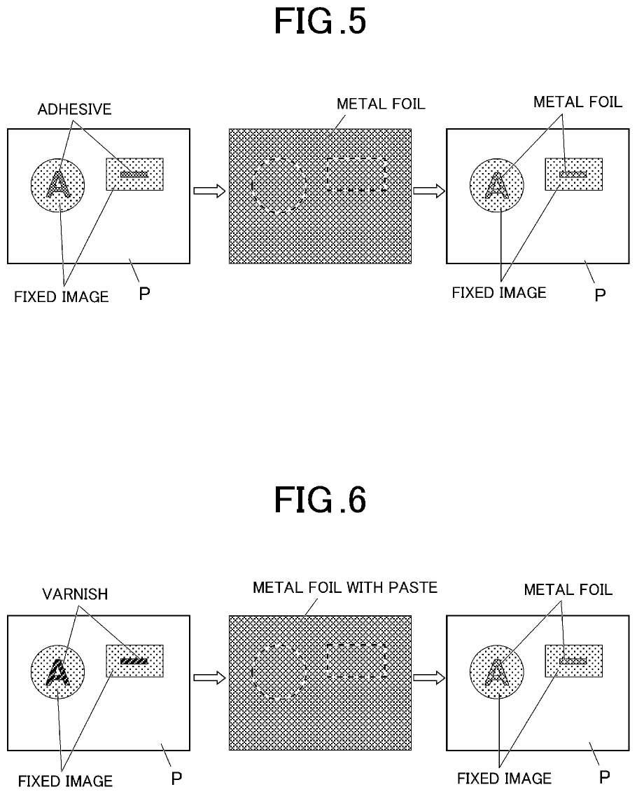

FIG. 5 is a conceptual diagram illustrating a reprocessing step of a fixed image in a cold foil method.

The processing by the cold foil method has an aspect in which fine expression is difficult due to a characteristic in which heat spreads from a plate portion, but has an advantage in that very fine foil expression equivalent to printing is possible since it is not necessary to form a mold as in foil pressing.

For example, processing by a cold foil method has a characteristic that a print can be put on a foil, and thus has an advantage that a metallic color with various color tones, which has not been seen in the past, can be expressed.

Further, in the processing by the hot stamp method, two steps of the printing step and the transfer by pressing the foil are required, but in the processing by the cold foil method, the foil can be applied (in-line foil) in the printing process, and therefore, there is an advantage that the working efficiency can be improved.

### (5.3) Spot Varnish+Foil Method

It is similar to the hot stamp method, but a plate is not used. This is a processing technique in which a varnish pattern is formed on a fixed image with a layer of the postprocessing liquid formed, a foil is placed on the varnish pattern after the varnish pattern is cured, and a decorative agent is applied by pressure bonding, so that the decorative agent is fixed only to a varnish portion of a convex portion.

FIG. 6 is a conceptual diagram showing a reprocessing step on a fixed image in the spot varnish+foil method.

Note that the formation of the varnish pattern may be performed by an analog format such as flexographic printing or gravure printing or by a digital format such as inkjet printing.

As a use example of the above-described “spot varnish processing”, for example, an inkjet UV spot varnish coater is used as mechanical equipment/material capable of performing spot varnish processing without a plate, and the inkjet UV spot varnish coater can be used in combination with a digital foil stamping machine. Thus, 3D spot varnish coating or the like having an embossing (thickening) effect is also enabled.

### 6. Details of Printing Material

A printing material according to the present invention contains a wax. The printing material is preferably an electrostatic charge image developing toner, and the electrostatic charge image developing toner contains toner particles containing a binder resin.

In the present invention, the term “toner particles” refers to toner base particles with an external additive added, and an aggregate of toner particles is referred to as “toner”.

In the following description, if it is not particularly necessary to distinguish between “toner base particles” and “toner particles”, they may be simply referred to as “toner particles”.

The toner base particles necessarily contain a wax, and may contain other components such as a charge control agent, if necessary, in addition to the binder resin and the coloring agent. Details of the wax are as described above.

### (6.1) Binder Resin

The binder resin preferably contains a styrene-acrylic resin from the viewpoint of low-temperature fixability. The ratio of the styrene-acrylic resin to the total resin is preferably 50% or more.

As a component other than the styrene-acrylic resin, a crystalline polyester resin or an aromatic polyester resin is preferably contained.

When the aromatic polyester resin is included, the adhesiveness between the cured film of the postprocessing liquid and the re-postprocessed layer is further improved due to the polarity of the aromatic polyester resin.

### Styrene-Acrylic Resin

The styrene-acrylic resin is a resin obtained by polymerization using at least an acrylic monomer.

Examples thereof include an acrylic resin and a styrene-acrylic copolymer resin.

The lower limit value of the content of the styrene-acrylic resin is preferably 5% by mass or more, more preferably 10% by mass or more, still more preferably 50% by mass or more, and particularly preferably 60% by mass or more, with respect to the total amount of the binder resin.

If the content is 5% by mass or more, the compatibility with the crystallized resin becomes better and the low-temperature fixing property becomes better.

The method for manufacturing the styrene-acrylic resin is not particularly limited. Examples of the manufacturing method include a method of performing polymerization by a known polymerization method such as a bulk polymerization method, a solution polymerization method, an emulsion polymerization method, a mini-emulsion method, or a dispersion polymerization method, using an appropriate polymerization initiator. As the polymerization initiator, any polymerization initiator such as a peroxide, a persulfide, a persulfate, or an azo compound, which is typically used for the polymerization of the monomer is used.

### Crystalline Polyester Resin

The crystalline polyester resin is a known polyester resin obtained by a polycondensation reaction of a divalent or more carboxylic acid (polycarboxylic acid component) and/or a hydroxycarboxylic acid with a divalent or more alcohol (polyhydric alcohol component). Among this, it refers to a resin which has a clear melting peak rather than a stepwise endothermic amount change in differential scanning calorimetry (DSC).

The clear melting peak specifically means a peak having a half-value width of the melting peak in the second heating process of 15° C. or less in the DSC curve obtained by differential scanning calorimetry of the crystalline polyester resin alone.

The melting point of the crystalline polyester resin is preferably within a range of 65 to 85° C., and more preferably within a range of 75 to 85° C. When the melting point of the crystalline polyester resin is in such a range, sufficient low-temperature fixability and excellent image storability are obtained.

The polycarboxylic acid component for forming the crystalline polyester resin is a compound containing two or more carboxy groups in one molecule.

Specific examples include saturated aliphatic dicarboxylic acids such as succinic acid, sebacic acid and dodecanedioic acid; alicyclic dicarboxylic acids such as cyclohexanedicarboxylic acid; aromatic dicarboxylic acids such as phthalic acid, isophthalic acid and terephthalic acid; trivalent or higher polycarboxylic acids such as trimellitic acid and pyromellitic acid; and anhydrides or alkyl esters having 1 to 3 carbon atoms of these carboxylic acid compounds.

As the polycarboxylic acid component for forming the crystalline polyester resin, a saturated aliphatic dicarboxylic acid is preferably used. These may be used alone, or two or more kinds thereof may be used in combination.

The polyhydric alcohol component for forming the crystalline polyester resin is a compound containing two or more hydroxy groups in one molecule.

Specific examples thereof include aliphatic diols such as ethylene glycol, 1,2-propanediol, 1,3-propanediol, 1,4-butanediol, 1,5-pentanediol, 1,6-hexanediol, 1,7-heptanediol, 1,8-octanediol, neopentyl glycol and 1,4-butenediol; and trihydric or higher polyhydric alcohols such as glycerin, pentaerythritol, trimethylolpropane and sorbitol.

As the polyhydric alcohol component for forming the crystalline polyester resin, an aliphatic diol is preferably used. These may be used alone, or two or more kinds thereof may be used in combination.

There is no particular limitation on the method for producing the crystalline polyester resin. The polyester resin can be produced by using a general polyester polymerization method in which the aforementioned polycarboxylic acid and polyhydric alcohol are reacted in the presence of a catalyst, and for example, it is preferable to produce the polyester resin by selectively using direct polycondensation or an ester exchange method according to the type of monomer.

### Aromatic [Amorphous] Polyester Resin

The amorphous polyester resin is a polyester resin which does not have a melting point and has a relatively high glass transition temperature (Tg) when differential scanning calorimetry (DSC) is performed.

Since the monomer that forms the amorphous polyester resin is different from the monomer that forms the crystalline polyester resin, the amorphous polyester resin can be distinguished from the crystalline polyester resin by, for example, analysis such as NMR.

The amorphous polyester resin is obtained by polycondensation reactions of divalent or more carboxylic acid (polycarboxylic acid) and divalent or more alcohol (polyalcohol). A specific amorphous polyester resin is not particularly limited, and conventionally known amorphous polyester resins in the present technical field can be used.

A specific method for producing the amorphous polyester resin is not particularly limited, and the resin can be produced by polycondensation (esterification) of a polycarboxylic acid and a polyhydric alcohol using a known esterification catalyst.

### Hybrid Resin

The aromatic [amorphous] polyester resin according to the present invention is preferably a hybrid amorphous polyester resin in which an aromatic [amorphous] polyester polymerization segment and a vinyl polymerization segment having a constitutional unit derived from styrene are chemically bonded.

More specifically, the aromatic [amorphous] polyester resin is preferably a hybrid aromatic [amorphous] polyester resin having a graft copolymer structure in which an aromatic [amorphous] polyester polymerization segment and a vinyl polymerization segment having a constitutional unit derived from styrene are chemically bonded.

In a case where such a hybrid aromatic [amorphous] polyester resin is used for the shell and the hybrid ratio (the mass % of the aromatic [amorphous] polyester polymerization segment with respect to the total amount of the hybrid aromatic [amorphous] polyester resin) is in a range of 70 to 99 mass %, coating of the core particle becomes easy.

Therefore, even in the case of a fixed image, the external additive present on the surface of the toner base particle is hardly buried, and the external additive can be maintained on the boundary line between the adjacent toner base particles.

The connection of the external additives present on the boundary line in this manner serves as a movement route of the charges, and thus it is possible to further suppress the sticking phenomenon.

The constituent components and the content ratio of each segment in the hybrid aromatic [amorphous] polyester resin can be specified by, for example, NMR measurement or methylation-reaction Py-GC/MS measurement.

The aromatic [amorphous] polyester polymerization segment is a portion derived from a known polyester resin obtained by a polycondensation reaction between a polycarboxylic acid component and a polyhydric alcohol component as in the aromatic [amorphous] polyester resin. It refers to a polymerization segment in which a clear endothermic peak is not observed in differential scanning calorimetry (DSC) of the toner.

The amorphous polyester polymerization segment is not particularly limited as long as it is as defined above.

For example, regarding a resin having a structure in which another component is copolymerized with a main chain composed of an amorphous polyester polymerization segment or a resin having a structure in which an amorphous polyester polymerization segment is copolymerized with a main chain composed of another component, if a toner containing this resin does not have a clear endothermic peak as described above, the resin corresponds to the hybrid amorphous polyester resin having an amorphous polyester polymerization segment in the present invention.

As a method for producing the hybrid amorphous polyester resin, an existing general scheme can be used. As representative methods, the following three methods are mentioned.

(1) A method of producing a hybrid amorphous polyester resin by polymerizing a vinyl polymerization segment in advance and performing a polymerization reaction for forming an amorphous polyester polymerization segment in the presence of the vinyl polymerization segment

(2) A method of producing a hybrid amorphous polyester resin by forming an amorphous polyester polymerization segment and a vinyl polymerization segment and bonding these segments

(3) A method of producing a hybrid amorphous polyester resin by polymerizing an amorphous polyester polymerization segment in advance and performing a polymerization reaction for forming a vinyl polymerization segment in the presence of the amorphous polyester polymerization segment

### (6.2) Coloring Agent

As the coloring agent, a generally known dye and pigment can be used.

As a coloring agent for obtaining a black toner, various known coloring agents exemplified by carbon black such as furnace black or channel black, magnetic material such as magnetite or ferrite, dye, or inorganic pigment including non-magnetic iron oxide can be used appropriately.

As a coloring agent for obtaining a color toner, any known coloring agent such as a dye or an organic pigment can be used.

The content of the coloring agent is preferably in the range of 1 to 20 parts by mass, and more preferably in the range of 4 to 15 parts by mass, with respect to 100 parts by mass of the binder resin.

### (6.3) Charge Control Agent

As the charge control agent, various known compounds can be used.

The content of the charge control agent is usually within a range of 0.1 to 5.0 parts by mass with respect to 100 parts by mass of the binder resin.

The content of the metal element in the toner particle can be measured by inductively coupled plasma-optical emission spectrometry (ICP-OES) as follows.

3 parts by mass of a sample (toner) is added to and dispersed in 35 parts by mass of a 0.2 mass% aqueous solution of polyoxyethylphenyl ether.

This dispersion is treated with an ultrasonic homogenizer US-1200T (manufactured by Nippon Seiki Corporation) at 25° C. for 5 minutes to remove the external additive from the toner surface, thus obtaining a sample for measurement.

### (6.4) External Additive

The toner particles according to the present invention can constitute the toner of the present invention as they are. In order to improve fluidity, charging property, cleaning property and the like, an external additive such as a fluidizing agent, a cleaning auxiliary or the like, which is a so-called posttreatment agent, may be added to the toner particles to constitute the toner of the present invention.

Examples of the posttreatment agent include inorganic oxide fine particles such as silica fine particles, alumina fine particles and titanium oxide fine particles, inorganic stearic acid compound fine particles such as aluminum stearate fine particles and zinc stearate fine particles, and inorganic titanate compound fine particles such as strontium titanate and zinc titanate.

These may be used alone or in combination of two or more kinds thereof.

These inorganic fine particles are preferably subjected to surface treatment with a silane coupling agent, a titanium coupling agent, a higher fatty acid, a silicone oil or the like in order to improve heat-resistant storage property and environmental stability.

The total added amount of these various external additives is in the range of 0.05 to 5 parts by mass, and preferably in the range of 0.1 to 3 parts by mass, with respect to 100 parts by mass of the toner.

Various external additives may be used in combination.

### (6.5) Developer

The toner of the present invention can be used as a magnetic or non-magnetic mono-component developer, but may be mixed with a carrier and used as a two-component developer.

As the carrier, for example, magnetic particles formed of a conventionally known material(s) exemplified by: metal such as iron, ferrite or magnesium; or an alloy of any of the metal and a metal such as aluminum or lead can be used, and among these, ferrite particles are preferably used.

As the carrier, a coated carrier in which the surface of a magnetic particle is coated with a coating agent such as a resin or a resin dispersion type carrier in which a magnetic fine powder is dispersed in a binder resin may be used.

The carrier preferably has a volume average particle diameter within a range of 15 to 100 μm, more preferably within a range of 25 to 80 μm.

### (6.6) Others

The average particle diameter of the toner particles according to the present invention is preferably in the range of 3 to 9 μm and more preferably in the range of 3 to 8 μm in terms of a volume-based median diameter (D50), for example.

For example, in a case where production is performed by adopting an emulsion aggregation method, which will be described later, the particle diameter can be controlled by the concentration of an aggregating agent to be used, the amount of an organic solvent to be added, a fusion time, and the composition of the polymer.

When the volume-based median diameter is within the above range, transfer efficiency increases, the image quality of halftones is improved, and the image quality of thin lines, dots, and the like is improved.

The toner particles according to the present invention preferably have an average circularity in the range of 0.930 to 1.000, and more preferably in the range of 0.950 to 0.995, from the viewpoint of improving transfer efficiency.

The softening point (Tsp) of the toner is preferably from 90 to 110° C.

When the softening point (Tsp) is within the above range, the influence of heat applied to the toner during fixing can be further reduced.

Since image formation can be performed without imposing a burden on the coloring agent, it is expected to exhibit a wider and more stable color reproducibility.

### Toner Production Method

Examples of methods for producing a toner include kneading and pulverizing methods, emulsion dispersion methods, suspension polymerization methods, dispersion polymerization methods, emulsion polymerization methods, emulsion polymerization aggregation methods, mini-emulsion polymerization aggregation methods, encapsulation methods, and other known methods.

Considering that it is necessary to obtain a toner having a small particle size in order to achieve higher image quality of an image, an emulsion polymerization aggregation method is preferably used from the viewpoint of production cost and production stability.

The emulsion polymerization aggregation method is a method as follows. First, a dispersion of fine particles of a binder resin (which hereinafter may be referred to as “binder resin fine particles”) produced by emulsion polymerization is mixed with a dispersion of fine particles of a coloring agent (which hereinafter may be referred to as “coloring agent fine particles”). Next, the fine particles are slowly aggregated while the repulsive force of the surfaces of the fine particles due to the pH adjustment and the cohesive force due to the addition of the aggregating agent including the electrolyte body are balanced. Next, the aggregation is performed while the average particle diameter and the particle size distribution are controlled, and at the same time, heating and stirring are performed to perform fusion between the fine particles and control the shape, so that a toner is produced.

In the method for producing a toner, the binder resin fine particle to be formed by using an emulsion polymerization aggregation method may have a configuration of two or more layers composed of binder resins having different compositions. In this case, it is possible to employ a method in which a polymerization initiator and a polymerizable monomer are added to a dispersion liquid of the first binder resin fine particles prepared by an emulsion polymerization treatment (first stage polymerization) according to an ordinary method, and this system is subjected to a polymerization treatment (second stage polymerization).

Further, the toner may have a core-shell structure. A method for producing the toner having a core-shell structure is as follows. First, binder resin fine particles for a core and coloring agent fine particles are associated, aggregated, and fused to prepare core particles. Next, binder resin fine particles for shell for forming a shell layer are added to the dispersion liquid of the core particles. Then, the fine binder resin particles for shell are aggregated and fused on the surface of the core particles to form a shell layer covering the surface of the core particles.

For the case where the toner has a core-shell structure, a production method thereof will be specifically described below separately in (1) to (9).

(1) Coloring agent fine particle dispersion liquid preparation step of preparing a dispersion liquid of coloring agent fine particles in which a coloring agent is dispersed in a form of fine particles

(2-1) Core binder resin fine particle polymerization step of obtaining core binder resin fine particles made of a core binder resin containing a main wax, an internal additive and the like, and preparing a dispersion liquid thereof

(2-2) Shell binder resin fine particle polymerization step of obtaining shell binder resin fine particles made of a shell binder resin and preparing a dispersion liquid thereof

(3) Aggregation and fusion step of aggregating and fusing core binder resin fine particles and coloring agent fine particles in an aqueous medium to form associated particles to be core particles

(4) First aging step of aging the associated particles with thermal energy to control the shape thereof, thereby obtaining core particles

(5) Shell layer forming step of forming particles having a core-shell structure by adding shell binder resin fine particles, which are to form a shell layer, to the dispersion liquid of the core particles, and aggregating and fusing the shell binder resin fine particles on the surface of the core particles

(6) Second aging step of aging the particles having a core-shell structure with thermal energy to control the shape thereof, thereby obtaining toner particles having a core-shell structure

(7) Filtering and washing step of performing solid-liquid separation to separate the toner particles from the cooled dispersion system (aqueous medium) of the toner particles and removing the surfactant and the like from the toner particles

(8) Drying step of drying the washed toner particle

If necessary, after the drying step, the following (9) may be added.

(9) External additive treatment step of adding an external additive to the dried toner particles

### (1) Coloring Agent Fine Particle Dispersion Liquid Preparation Step

In this step, a coloring agent is added to an aqueous medium and dispersed with a disperser to prepare a dispersion liquid of coloring agent fine particles in which the coloring agent is dispersed in the form of fine particles.

Specifically, the dispersion treatment of the coloring agent is performed in an aqueous medium in a state where the concentration of a surfactant is set to a critical micelle concentration (CMC) or more. The disperser used for the dispersion treatment is not particularly limited, but preferable examples thereof include pressure dispersing machines such as an ultrasonic disperser, a mechanical homogenizer, Manton Gaulin and a pressure homogenizer, and medium-type dispersing machines such as a sand grinder, a Getzmann mill and a diamond fine mill.

The dispersion diameter of the coloring agent fine particles in the coloring agent fine particle dispersion liquid is preferably within a range of 40 to 200 nm in terms of the volume-based median diameter.

The volume-based median diameter of the coloring agent fine particle is measured using “MICROTRAC UPA-150 (manufactured by HONEYWELL Corporation)” under the following measurement conditions.

### Measurement Conditions

Sample Refractive Index: 1.59
Sample Specific Gravity: 1.05 (in terms of spherical particle)
Solvent Refractive Index: 1.33
Solvent Viscosity: 0.797 (30° C.), 1.002 (20° C.)
Zero Point Adjustment: Adjusted by putting ion-exchanged water to measurement cell

### (2-1) Core Binder Resin Fine Particle Polymerization Step

In this step, a polymerization treatment is performed to prepare a dispersion liquid of core binder resin fine particles, which are made of a core binder resin containing a main wax, an internal additive and the like.

In a suitable example of the polymerization treatment in this step, a polymerizable monomer solution containing a main wax, an internal additive and the like as necessary is added to an aqueous medium containing a surfactant having a critical micelle concentration (CMC) or less. Then, drops are formed by applying mechanical energy, and then a water-soluble polymerization initiator is added to allow a polymerization reaction to proceed in the drops.

The drops may contain an oil-soluble polymerization initiator. In such a step, a treatment of forcibly emulsifying (forming liquid drops) by applying mechanical energy is essential. Examples of the means for providing such mechanical energy include means for providing strong stirring or ultrasonic vibration energy, such as a homomixer, ultrasonic waves, and Manton Gaulin.

### Surfactant

A surfactant used in the aqueous medium used for the coloring agent fine particle dispersion liquid or at the time of polymerization of the core binder resin fine particles will be described.

The surfactant is not particularly limited, but preferable examples include ionic surfactants that include sulfonic acid salts (sodium dodecylbenzenesulfonate, sodium arylalkyl polyether sulfonate), sulfuric acid ester salts (sodium dodecyl sulfate, sodium tetradecyl sulfate, sodium pentadecyl sulfate, sodium octyl sulfate and the like), fatty acid salts (sodium oleate, sodium laurate, sodium caprate, sodium caprylate, sodium caproate, potassium stearate, calcium oleate and the like).

Other usable examples include nonionic surfactants that include polyethylene oxide, polypropylene oxide, a combination of polypropylene oxide and polyethylene oxide, an ester of polyethylene glycol and a higher fatty acid, alkylphenol polyethylene oxide, an ester of a higher fatty acid and polyethylene glycol, an ester of a higher fatty acid and polypropylene oxide, and sorbitan ester.

Hereinafter, the polymerization initiator and the chain transfer agent used in the core binder resin fine particle polymerization step will be described.

### Polymerization Initiator

Examples of the water-soluble polymerization initiator include persulfates such as potassium persulfate and ammonium persulfate, azobisaminodipropane acetate, azobiscyanovaleric acid and salts thereof, and hydrogen peroxide.

Examples of the oil-soluble polymerization initiator include azo-based or diazo-based polymerization initiators such as 2,2′-azobis-(2,4-dimethylvaleronitrile), 2,2′-azobisisobutyronitrile, 1,1′-azobis (cyclohexane-1-carbonitrile), 2,2′-azobis-4-methoxy-2,4-dimethylvaleronitrile and azobisisobutyronitrile, peroxide-based polymerization initiators such as benzoyl peroxide, methyl ethyl ketone peroxide, diisopropylperoxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl) propane and tris-(t-butylperoxy) triazine, and polymer initiators having a peroxide in a side chain.

### Chain Transfer Agent

For the purpose of adjusting the molecular weight of the core binder resin to be obtained, a generally used chain transfer agent can be used.

The chain transfer agent is not particularly limited, and usable examples thereof include mercaptans such as N-octyl mercaptan, N-decyl mercaptan and tert-dodecyl mercaptan, mercaptopropionic acid esters such as N-octyl-3-mercaptopropionic acid ester, terpinolene and α-methylstyrene dimer and the like.

### (2-2) Shell Binder Resin Fine Particle Polymerization Step

In this step, a polymerization treatment is performed in the same manner as in the above-described (2-1) core binder resin fine particle polymerization step to prepare a dispersion liquid of shell binder resin fine particles, which are made of a shell binder resin.

### (3) Aggregation and Fusion Step

In this step, a treatment is performed in which core binder resin fine particles and coloring agent fine particles are aggregated and fused in an aqueous medium to form associated particles which are to be core particles.

As a method for aggregation and fusion in this step, a salting-out/fusion method using the coloring agent fine particles obtained in the (1) coloring agent fine particle dispersion liquid preparation step and the core binder resin fine particles obtained in the (2-1) core binder resin fine particle polymerization step is preferable.

In the aggregation and fusion step, wax fine particles and/or internal additive fine particles of a charge control agent or the like can be aggregated and fused together with the core binder resin fine particles and the coloring agent fine particles.

The “salting-out/fusion” means that aggregation and fusion proceed in parallel, and when the particles grow to a desired particle diameter, an aggregation terminator is added to stop the particle growth, and further, if necessary, heating for controlling the particle shape is continuously performed.

In the salting-out/fusion method, a salting-out agent composed of an alkali metal salt, an alkaline earth metal salt, a trivalent salt and/or the like is added as a flocculant of a critical aggregation concentration or more to an aqueous medium in which the core binder resin fine particles and the coloring agent fine particles are present. Next. the resultant is heated to a temperature which is equal to or higher than the glass transition point of the core binder resin fine particles and is equal to or higher than the melting peak temperature of the core binder resin fine particles and the coloring agent fine particles, and thus salting-out is allowed to proceed, and at the same time, aggregation and fusion are performed.

Regarding the alkali metal salt as the salting-out agent, examples of the alkali metal include lithium, potassium and sodium. Regarding the alkaline earth metal salt as the salting-out agent, examples of the alkaline earth metal include magnesium, calcium, strontium and barium, and preferred examples thereof include potassium, sodium, magnesium, calcium and barium.

When the aggregation and fusion step is carried out by salting-out/fusion, it is preferable to shorten the standing time after adding the salting-out agent as much as possible.

The reason for this is not clear, but depending on the standing time after salting out, the state of aggregation of the particles fluctuates, or problems arise, for example, that the particle diameter distribution becomes unstable and that the surface property of the fused toner fluctuates.

The temperature at which the salting-out agent is added needs to be at least equal to or lower than the glass transition point of the core binder resin fine particles.

The reason for this is that when the temperature at which the salting-out agent is added is higher than the glass transition point of the core binder resin fine particles, the salting-out/fusion of the core binder resin fine particle rapidly proceeds, but the particle diameter cannot be controlled, and a problem arises in that particles having a large particle diameter are generated.

The range of this adding temperature may be any temperature as long as it is equal to or lower than the glass transition point of the binder resin, but is generally within a range of 5 to 55° C., and preferably within a range of 10 to 45° C.

A salting-out agent is added at a temperature of the glass transition point of the core binder resin fine particles or lower, and then the temperature is increased as quickly as possible to a temperature that is the glass transition point or higher of the core binder resin fine particles and the melting peak temperature (° C.) or higher of the core binder resin fine particles and the coloring agent fine particles.

The time until the temperature increase is preferably less than 1 hour. The temperature increase needs to be performed rapidly, and the temperature increase rate is preferably 0.25° C./min or more.

The upper limit is not particularly clear, but since salting-out rapidly proceeds when the temperature is increased instantaneously, there is a problem that it is difficult to control the particle diameter, and therefore 5° C./min or less is preferable.

By the above-mentioned salting-out/fusion method, a dispersion liquid of associated particles (core particles) formed by salting-out/fusion of the core binder resin fine particles and optional fine particles is obtained.

The “aqueous medium” refers to a medium consisting of 50 to 100% by mass of water and 0 to 50% by mass of a water-soluble organic solvent.

Examples of the water-soluble organic solvent include methanol, ethanol, isopropanol, butanol, acetone, methyl ethyl ketone, and tetrahydrofuran. Of these, alcohol-based organic solvents that do not dissolve the resin to be produced are preferable.

### (4) First Aging Step

In this step, a treatment of aging the associated particles with thermal energy is performed. By controlling the heating temperature in the (3) aggregation and fusion step and in particular the heating temperature and time in the (4) first aging step, it is possible to perform control such that the surface of the core particles formed so as to have a uniform particle diameter and a narrow distribution has a smooth and uniform shape.

Specifically, the surface of the core particles can be controlled to have a uniform shape as follows: in the (3) aggregation and fusion step, the heating temperature is controlled to be low to suppress the progress of fusion between the core binder resin fine particles and promote uniformity, and in the first aging step, the heating temperature and the time are controlled to be low and long, respectively.

### (5) Shell Layer Forming Step

In this step, a shelling treatment to form particles having a core-shell structure is performed in which a dispersion liquid of shell binder resin fine particles is added to a dispersion liquid of core particles to aggregate and fuse the shell binder resin fine particles on the surface of the core particles, so that the surface of the core particles is covered with the shell binder resin fine particles.

This step is a preferable production condition for imparting both low-temperature fixability and heat-resistant storage property. In the case of forming a color image, in order to obtain high color reproducibility for a secondary color, it is preferable to perform this shell layer formation.

Specifically, the dispersion liquid of the shell binder resin fine particles is added to the dispersion liquid of the core binder resin fine particles while the heating temperature in the (3) aggregation and fusion step and the (4) first aging step is kept. While heating and stirring are continued, the surface of the core particles are covered/coated with the shell binder resin fine particles slowly over several hours to form particles having a core-shell structure. The heating and stirring time is preferably within a range of 1 to 7 hours, and particularly preferably within a range of 3 to 5 hours.

### (6) Second Aging Step

In this step, when the particles having a core-shell structure have a predetermined particle diameter in the (5) shell layer forming step, a terminator such as sodium chloride is added to stop the particle growth. Heating and stirring are continued thereafter too for several hours in order to fuse the shell binder resin fine particles adhered to the core particles.

The thickness of the layer of the shell binder fine particles coating the surface of the core particles is in the range of 100 to 300 nm.

Thus, the shell binder resin fine particles are adhered to the surface of the core particles to form a shell layer, and toner particles having a core-shell structure that are rounded and have a uniform shape are formed.

### (7) Filtration and Washing Step

In this step, first, a treatment of cooling the dispersion liquid of the toner particles is performed. As a cooling treatment condition, it is preferable to perform cooling at a cooling rate of 1 to 20° C./min.

The cooling treatment method is not particularly limited, and examples thereof include a method of cooling by introducing a refrigerant from the outside of a reaction vessel, and a method of cooling by directly putting cold water into a reaction system.

Next, the toner particles are separated from the dispersion liquid of the toner particles cooled to a predetermined temperature, and thereafter, a washing treatment is performed in which adhering substances such as a surfactant and a salting-out agent are removed from a toner cake (an aggregate obtained by aggregating the toner particles in a wet state into the shape pf a cake) obtained by the solid-liquid separation.

The filtration treatment method is not particularly limited, and examples thereof include a centrifugal separation method, a reduced pressure filtration method using Nutsche or the like, and a filtration method using a filter press or the like.

### (8) Drying Step

In this step, a treatment of drying the washed toner cake is performed. Examples of the dryer used in this step include a spray dryer, a vacuum freeze dryer, a reduced pressure dryer and the like, and it is preferable to use a stationary shelf dryer, a movable shelf dryer, a fluid bed dryer, a rotary dryer, a stirring dryer or the like.

The water content of the dried toner particles is preferably 5% by mass or less, more preferably 2% by mass or less.

When the dried toner particles are aggregated by a weak inter-particle attractive force, the aggregate may be subjected to a crushing treatment.

As a crushing treatment apparatus, a mechanical crushing apparatus such as a jet mill, a Henschel mixer, a coffee mill or a food processor can be used.

### (9) External Addition Treatment Step

In this process, a treatment of adding an external additive to the toner particles dried in the (8) drying step is performed.

As a method for adding the external additive, for example, a mechanical mixing apparatus such as a Henschel mixer or a coffee mill can be used.

### II. Image Forming System

The image forming system of the present invention includes: an apparatus that forms an image with a printing material containing a wax on a recording medium; an apparatus that applies a postprocessing liquid onto the image as postprocessing; and an apparatus that forms a layer of the postprocessing liquid, wherein the interfacial tension of the postprocessing liquid to water is within a range of 2 to 13 mN/m at 25° C.

Specifically, it is preferable that the postprocessing liquid according to the present invention is combined with the below-described image forming apparatus and applying apparatus for a postprocessing liquid to be a system for carrying out an image forming method of the present invention.

### (1) Means (Device/Apparatus) for Forming Image on Recording Medium with Printing Material Containing Wax

In the present invention, the printing material used for forming an image on a recording medium contains a wax.

The means for forming an image is installed in the “fixed image forming section” in FIG. 1. The above-described means is not particularly limited, but is preferably a means employing an electrophotographic method or an inkjet method from the viewpoint of the fixability of the image.

It is preferable that the means is a means adopting the roll-to-roll method from the viewpoint of productivity because the postprocessing and the re-postprocessing can be performed continuously (in-line).

The recording medium and the printing material are as described above.

Preferably, the surface tension of the image is within a range of 18 to 30 mN/m, more preferably a range of 18 to 25 mN/m, at 25° C. from the viewpoint of the application property of the postprocessing liquid to the fixed image.

### (2) Means (Device/Apparatus) for Applying Postprocessing Liquid onto Image

Onto the image formed with the printing material containing wax on the recording medium according to the present invention, the postprocessing liquid is applied as postprocessing.

The means for applying the postprocessing liquid is installed in the “postprocessing section” in FIG. 1. Such a means is not particularly limited, but examples thereof include means adopting, for example, a roll coating method, an inkjet method, a spraying method, and application by a gravure printing machine or a flexographic printing machine, and among them, the means adopting a roll coating method is preferable.

### (3) Means (Device/Apparatus) for Forming Layer of Postprocessing Liquid

The concept of the “liquid” according to the present invention includes a liquid state having fluidity such as wettability or permeability immediately after the “liquid” is applied onto the fixed image, and a state after that (a state after drying).

The “liquid state having fluidity” refers to a state in which the liquid moves so as to wet-spread or permeate on the fixed image.

The means for forming the layer of the postprocessing liquid is installed in front of the “curing section” included in the “postprocessing section” in FIG. 1, and examples thereof include a dryer.

### (4) Means (Device/Apparatus) for Curing Layer of Postprocessing Liquid

The image forming system of the present invention preferably has a means for curing the layer of the postprocessing liquid.

It is preferable that the postprocessing liquid is a photocurable postprocessing liquid containing an active ray reactive monomer, a silicone-based compound and a polymerization initiator, and the means for curing the layer of the postprocessing liquid is a means for irradiating the layer with an active ray, from the viewpoint of controlling the surface tension of the post-possessed fixed image.

It is preferable that the layer of the postprocessing liquid according to the present invention is cured by being irradiated with light using a photocurable postprocessing liquid as the postprocessing liquid to form a cured film of the postprocessing liquid.

The layer of the postprocessing liquid according to the present invention is preferably formed into a cured film of the postprocessing liquid by being cured, which improves re-postprocessing property.

The means for curing the layer of the postprocessing liquid is installed as a curing apparatus in the “curing section” included in the “postprocessing section” in FIG. 1, and examples of the curing apparatus include a light emitter.

A cured film of the postprocessing liquid is formed by irradiation with light emitted from the aforementioned light emitter.

Examples of the light include ultraviolet rays, and the cured film of the postprocessing liquid formed by irradiation with the ultraviolet rays has a surface tension of 30 mN/m or more.

The thickness of the cured film of the postprocessing liquid is preferably within a range of 1 to 10 mm from the viewpoint of improving the re-postprocessing property.

### (5) Means (Device/Apparatus) for Forming Re-postprocessed Layer on Layer of Postprocessing Liquid or Cured Film of Postprocessing Liquid

As described above, in the present specification, the term “re-postprocessing” refers to a processing treatment (processing treatment(s) after the first time), such as application of a decorative agent, which is performed after the postprocessing. The “re-postprocessed layer” refers to a layer formed by the re-postprocessing on the layer of the postprocessing liquid described above.

The polarity of the postprocessing liquid according to the present invention, that is, the interfacial tension of the postprocessing liquid with respect to water is controlled. Thus, the surface tension of the cured film of the postprocessing liquid is controlled to be higher than that of the re-postprocessed layer formed by the re-postprocessing treatment (e.g., application of a decorative agent such as a foil).

As a result, not only the application property of the postprocessing liquid to the fixed image is improved, but also the adhesiveness to the re-postprocessed layer is improved.

The means for forming a re-postprocessed layer on the layer of the postprocessing liquid or the cured film of the postprocessing liquid is installed in the “re-postprocessing section” in FIG. 1.

The decorative agent used for the re-postprocessing in the “re-postprocessing section”, the method of the re-postprocessing, and the like are as described above.

### III. Image Forming Apparatus

Specific examples of the method of the image forming apparatus used for the method of forming an image on a recording medium with a printing material containing a wax include the following (1) and (2).

(1) So-called direct transfer method in which an image is formed through a step of directly transferring a toner image formed by developing an electrostatic latent image formed on an electrostatic latent image bearing member with a toner onto an image support and a step of heat-fixing the toner image borne on the image support

(2) So-called intermediate transfer method in which an image is formed through a step of transferring a

toner image formed by developing an electrostatic latent image formed on an electrostatic latent image bearing member with a toner onto an intermediate transfer body, a step of transferring the toner image transferred onto the intermediate transfer body onto an image support, and a step of heat-fixing the toner image borne on the image support

Hereinafter, an image forming apparatus for the above (2) image forming method will be described.

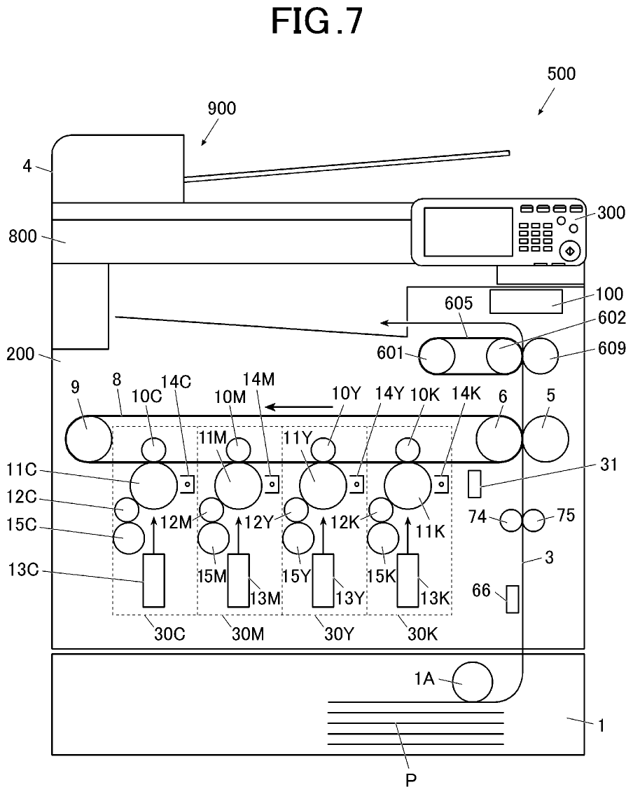

FIG. 7 is a schematic diagram of an image forming apparatus. An example of the image forming apparatus used in the present invention is an image forming apparatus equipped with a tandem-type color image forming unit as illustrated in FIG. 7.

An image forming apparatus (MFP) 500 includes a controller 100 and an image forming section 200.

The image forming section 200 typically forms a color or monochrome image on a sheet P loaded in a sheet feed cassette 1 based on image information obtained by a scanner unit 800 optically reading the contents of a document to be printed.

An auto document feeder (ADF) 900 is connected to the scanner unit 800, and documents to be printed are sequentially conveyed from the ADF 900.

To be more specific, the image forming section 200 includes process units 30C, 30M, 30Y, and 30K (which hereinafter may be referred to as “process units 30”) for four colors of cyan (C), magenta (M), yellow (Y), and black (K), respectively.

The process units 30 for the respective colors are arranged along the movement direction of a transfer belt 8, and sequentially form toner images of their respective colors on the transfer belt 8.

The process units 30C, 30M, 30Y and 30K contain primary transfer rollers 10C, 10M, 10Y and 10K (which hereinafter may be referred to as “primary transfer rollers 10”). photoreceptors 11C, 11M, 11Y and 11K (which hereinafter may be referred to as “photoreceptors 11”), developing rollers 12C, 12M, 12Y and 12K (which hereinafter may be referred to as “developing rollers 12”), print heads 13C, 13M, 13Y and 13K (which hereinafter may be referred to as “print heads 13”), chargers 14C, 14M, 14Y and 14K (which hereinafter may be referred to as “chargers 14”), and toner units 15C, 15M, 15Y and 15K (which hereinafter may be referred to as “toner units 15”).

Upon receiving a print request in response to a user's operation on an operation panel 300 or the like, each process unit 30 forms, on its photoreceptor 11, a toner image of its color constituting an image to be printed. At the same time, each process unit 30 transfers the formed toner image of the color onto the transfer belt 8 in synchronization with the other process unit(s) 30.

At this time, the primary transfer rollers 10 move the toner images on their corresponding photoreceptors 11 to the transfer belt 8.

In each process unit 30, the charger 14 charges the surface of the rotating photoreceptor 11, and the print head 13 exposes the surface of the photoreceptor 11 in accordance with image information to be printed.

As a result, an electrostatic latent image for a toner image to be formed is formed on the surface of the photoreceptor 11.

Thereafter, the developing roller 12 supplies toner of the toner unit 15 onto the surface of the photoreceptor 11.

As a result, the electrostatic latent image is developed as a toner image on the photoreceptor 11.

Thereafter, the primary transfer rollers 10 sequentially transfer the toner images developed on the surfaces of the photoreceptors 11 onto the transfer belt 8 being rotated by a drive motor 9.

Thus, the toner images of the respective colors are superimposed to form a toner image to be transferred to the sheet P.

The image forming section 200 includes a concentration sensor 31 for detecting the toner concentration on the transfer belt 8 to stabilize the concentration of a toner image to be printed.

As image stabilization control using the concentration sensor 31, several patches for toner concentration detection are formed/printed on the transfer belt 8 with different toner concentrations by changing the developing output of the developing device(s).

The image forming section 200 detects the toner concentration using the concentration sensor 31, and performs feedback to the developing output of the developing device(s) according to the detection result, so that it is possible to always obtain a stable toner concentration at the time of printing.

The image stabilization control can be executed in a case where a main switch of the apparatus main body is turned on, a case where the toner cartridge is replaced, a case where a predetermined number of sheets are printed, and the like.

The image forming section 200 includes the sheet feed cassette 1.

In the sheet feed cassette 1, a sheet feed roller 1A picks up a sheet P loaded in the sheet feed cassette 1.

The picked-up sheet P is conveyed along a conveyance path 3 by a conveyance roller 74 and so forth.

The conveyance roller 74 causes the sheet P to wait when the sheet P reaches a timing sensor.

Thereafter, the conveyance roller 74 conveys the sheet P to a secondary transfer roller 5 in synchronization with the timing at which the toner image formed on the transfer belt 8 reaches the secondary transfer roller 5.

The toner image on transfer belt 8 is transferred onto the sheet P by the secondary transfer roller 5 and a counter roller 6.

Typically, a predetermined potential (e.g., about +2,000 V) corresponding to the charge of the toner image is applied to the secondary transfer roller 5 in advance, so that a force that electrically attracts the toner image on the transfer belt 8 to the secondary transfer roller 5 side is generated, and thus the toner image is transferred to the sheet P.

The toner image transferred to the sheet P is processed in a fixing device including a fixing belt 605, a pressure roller 609 and the like to be fixed on the sheet P.

The sheet P on which the toner image has been fixed is output to a sheet ejection tray. Accordingly, a series of print processes is completed.

In the image forming apparatus (MFP) 500, the fixing belt 605 is an example of a fixing member, and the pressure roller 609 is an example of a pressure member.

A smoothness sensor 66 is disposed along the conveyance path 3. The smoothness sensor 66 detects the smoothness of the surface of the sheet P on the conveyance path 3, and outputs the detection result to the controller 100.

The image forming apparatus (MFP) 500 can include, as the smoothness sensor 66, a sensor of any method including an air leakage method.

### IV. Postprocessing Liquid Applying Apparatus

The applying apparatus for the postprocessing liquid of the present invention is characterized in that a postprocessing liquid is applied onto an image formed with a printing material containing a wax, and is suitably used for the image forming method of the present invention.

The applying apparatus for the postprocessing liquid is not particularly limited as long as it can apply the above-described postprocessing liquid, but is preferably an applying apparatus capable of employing a roll coating method from the viewpoint of the application property of the postprocessing liquid to the fixed image.

### EXAMPLES

Hereinafter, the present invention will be specifically described with reference to Examples, but the present invention is not limited thereto. In Examples, “part (s)” or “%” means “part (s) by mass” or “% by mass” unless otherwise specified.

### Production of Toner

A. Preparation of Dispersion Liquid

(A.1) Preparation of Amorphous Vinyl Resin Particle Dispersion Liquid X1

### First Stage Polymerization: Preparation of Polymer Fine Particle Dispersion Liquid a1

Into a 5 L reaction vessel equipped with a stirrer, a temperature sensor, a cooling tube and a nitrogen-introduction device, 8 parts by mass of sodium dodecylsulfate and 3,000 parts by mass of ion-exchanged water were put, and the internal temperature of the reaction vessel was increased to 80° C. while the mixture was being stirred at a stirring speed of 230 rpm under the nitrogen flow.

After the temperature increase, to the obtained mixture solution, an aqueous solution in which 10 parts by mass of potassium persulfate was dissolved in 200 parts by mass of ion-exchanged water was added, and the temperature of the obtained mixture solution was adjusted to 80° C. again.

To the mixture solution, a monomer mixture liquid 1 having the following composition was added dropwise over 1 hour, and then the mixture solution was heated and stirred at 80° C. for 2 hours to perform polymerization, so that a resin fine particle dispersion liquid al was prepared.

### Composition of Monomer Mixture Solution 1

Styrene: 480 parts by mass
Methyl Acrylate: 250 parts by mass
Methacrylic Acid: 68 parts by mass

### Second Stage Polymerization: Preparation of Resin Fine Particle Dispersion Liquid a2

Into a 5 L reaction vessel equipped with a stirrer, a temperature sensor, a cooling tube and a nitrogen-introduction device, a solution in which 7 parts by mass of sodium polyoxyethylene (2) dodecyl ether sulfate was dissolved in 3,000 parts by mass of ion-exchanged water was put. Then, after the mixture was heated to 80° C., 80 parts by mass of the resin fine particle dispersion liquid al (in terms of solid) and a monomer mixture liquid 2 having the following composition and containing monomer and wax dissolved at 90° ° C.were added. Then, mixing and dispersing were performed for 1 hour using a mechanical disperser “CLEARMIX” (manufactured by M Technique Co., Ltd., wherein “CLEARMIX” is a registered trademark of the same company) having a circulation path. Thus, a dispersion liquid containing emulsified particles (oil drops) was prepared. Note that behenyl behenate mentioned below is an ester-based wax, and its melting point is 73° C.

### Composition of Monomer Mixture Solution 2

Styrene: 285 parts by mass
Methyl Acrylate: 95 parts by mass
Methacrylic Acid: 20 parts by mass
Behenyl Behenate (Ester-based Wax): 190 parts by mass

To the dispersion liquid, an initiator solution in which 6 parts by mass of potassium persulfate was dissolved in 200 parts by mass of ion-exchanged water was added, and the obtained dispersion liquid is heated and stirred at 84° C.for 1 hour to perform polymerization, so that a resin fine particle dispersion liquid a2 was prepared.

### Third Stage Polymerization: Preparation of Amorphous Vinyl Resin Particle Dispersion Liquid X1

Further, to the resin fine particle dispersion liquid a2, 400 parts by mass of ion-exchanged water was added, and after these are sufficiently mixed, to the obtained dispersion liquid, a solution in which 11 parts by mass of potassium persulfate was dissolved in 400 parts by mass of ion-exchanged water was added. Then, under a temperature condition of 82° C., a monomer mixture liquid 3 having the following composition was added dropwise over 1 hour.

### Composition of Monomer Mixture Solution 3

Styrene: 307 parts by mass
Methyl Acrylate: 147 parts by mass
Methacrylic Acid: 52 parts by mass

After the completion of the dropwise addition, the dispersion liquid was heated and stirred for 2 hours for polymerization and then cooled to 28° C., so that an amorphous vinyl resin particle dispersion liquid X1 composed of vinyl resin (styrene-acrylic resin) was prepared.

The physical properties of the obtained amorphous vinyl resin particle dispersion liquid X1 were measured. As a result, the volume-based median diameter (d50) of the amorphous resin fine particles was 220 nm, the glass transition temperature (Tg) thereof was 46° C., and the weight average molecular weight (Mw) thereof was 32,000.

### (A.2) Preparation of Amorphous Vinyl Resin Particle Dispersion Liquid X2

In order to prepare an amorphous vinyl polymer particle dispersion liquid X2, behenyl behenate (ester-based wax) in the composition of the monomer mixture solution 2 used for the second stage polymerization in the preparation of the amorphous vinyl polymer particle dispersion liquid X1 was changed to “HNP-0190” (hydrocarbon-based wax). Other than the above, the amorphous vinyl polymer particle dispersion liquid X2 was prepared in the same manner as the amorphous vinyl resin particle dispersion liquid X1.

### (A.3) Preparation of Crystalline (Unmodified Aliphatic) Polyester Resin Particle Dispersion Liquid CP1

Into a 5 L reaction vessel equipped with a stirrer, a temperature sensor, a cooling tube and a nitrogen-introduction device, 300 parts by mass of sebacic acid as polycarboxylic acid and 170 parts by mass of 1,6-hexanediol as polyhydric alcohol were put. The internal temperature was increased to 190° C. by the mixture being stirred over 1 hour.

After it was confirmed that the mixture was in a uniformly stirred state, as a catalyst, 0.003% by mass of Ti(OBu)₄ based on the put amount of the polycarboxylic acid.

While generated water was distilled off, the internal temperature was increased from 190° C. to 240° C. over 6 hours, and a dehydration condensation reaction was continued at a temperature of 240° C. over 6 hours to perform polymerization, so that a crystalline polyester resin was obtained.

The melting point (Tm) of the crystalline polyester resin was 66.8° C., and the number average molecular weight (Mn) thereof was 6,300.

Into a jacketed 3 L reactor (BJ-30N, manufactured by TOKYO RIKAKIKAI CO., LTD) equipped with a condenser, a thermometer, a water dropping device and an anchor blade, 300 parts by mass of the above crystalline polyester resin, 160 parts by mass of methylethyl ketone (solvent) and 100 parts by mass of isopropyl alcohol (solvent) were put. The mixture was kept at 70° C. in a water-circulating constant-temperature tank while being stirred and mixed at 100 rpm to dissolve the resin.

Thereafter, the stirring rotation speed was set to 150 rpm, the water-circulating constant-temperature tank was set to 66° C., and 17 parts by mass of 10 mass % aqueous ammonia (reagent) was put over 10 minutes. Thereafter, 900 parts by mass of ion-exchanged water in total kept at 66° C. was added dropwise thereto at a rate of 7 parts by mass/min to cause phase inversion, so that an emulsion was obtained.

Immediately, 800 parts by mass of the obtained emulsion and 700 parts by mass of ion-exchanged water were put into a 2 L eggplant flask, and the flask was set in an evaporator (manufactured by Tokyo Rikakikai Co., Ltd) provided with a vacuum control unit via a trap ball.

The eggplant flask was heated in a 60° C. hot water bath while being rotated, and pressure was reduced to 7 kPa while attention was paid to bumping, thus removing the solvent(s). When the solvent recovered amount reached 1,100 parts by mass, the pressure was returned to normal pressure, and the eggplant flask was cooled with water, so that a dispersion liquid was obtained.

The obtained dispersion liquid had no solvent odor.

The volume-based median diameter (D50) of the resin particles in the dispersion liquid was 130 nm. Thereafter, ion-exchanged water was added thereto to adjust the solid concentration to 20% by mass, and thus the crystalline polyester resin particle dispersion liquid CP1 was prepared.

### (A.4) Preparation of Coloring Agent Dispersion Liquid Cy1

To 1,600 parts by mass of ion-exchanged water, 90 parts by mass of sodium dodecyl sulfate was added. While this solution was stirred, 420 parts by mass of copper phthalocyanine (C. I. Pigment Blue 15:3) was gradually added thereto. Next, dispersion treatment was performed using a stirrer “CLEARMIX” (manufactured by M Technique Co., Ltd), so that an aqueous dispersion liquid of coloring agent particles (coloring agent dispersion liquid) (Cy1) was prepared.

The volume-based median diameter (D50) of the coloring agent particles of the obtained aqueous dispersion liquid (Cy1) was 110 nm.

### B. Production of Toner

### (B.1) Production of Toner 1

Into a reaction vessel equipped with a stirrer, a temperature sensor and a cooling tube, 315 parts by mass (in terms of solid basis) of the amorphous vinyl resin particle dispersion liquid X1 (for core), 30 parts by mass (in terms of solid) of the crystalline polyester resin particle dispersion liquid CP1, 1% by mass (in terms of solid) of sodium dodecyldiphenyl ether disulfonate on a resin basis and 2,000 parts by mass of ion-exchanged water were put.

At room temperature (25° C.), a 5 mol/L aqueous sodium hydroxide solution was added to adjust the pH to 10.

Further, 30 parts by mass (in terms of solid) of the coloring agent particle dispersion liquid Cy1 was put, and a solution in which 30 parts by mass of magnesium chloride was dissolved in 30 parts by mass of ion-exchanged water was added at 30° C. over 10 minutes under stirring. The mixture was allowed to stand for 3 minutes and heated to 80° C. over 60 minutes.

The stirring speed was adjusted so that the growth speed of the particle diameter became 0.01 μm/min, and the particle size was grown until the volume-based median diameter (D50) measured by coulter multisizer 3 (manufactured by Beckman Coulter) became 6.0 μm.

Subsequently, an aqueous solution in which 190 parts by mass of sodium chloride was dissolved in 760 parts by mass of ion-exchanged water was added to stop the growth of the particle diameter. Then, the mixture was heated to and stirred at 80° C. to promote fusion of the particles until the average circularity of the toner base particles reached 0.965, and the following washing and drying step was performed.

### Washing and Drying Step

The dispersion liquid of the toner base particles produced in the aggregation and fusion step was subjected to solid-liquid separation using a basket-type centrifuge to form a wet cake of the toner base particles.

This wet cake was washed with 35° C. ion-exchanged water, and then adjusted with a 25% aqueous sodium hydroxide solution until the pH reached 4.0 (corresponding to a net strength of 0.10).

The wet cake was washed with 35° C. ion-exchanged water until the electric conductivity of the filtrate became 5 μS/cm with the basket-type centrifuge, then transferred to “Flash Jet Dryer (manufactured by Seishin Enterprise Co., Ltd)”, and dried until the water amount became 0.5% by mass, so that toner base particles 1 were produced.

### External Additive Treatment Step

To the toner base particles 1, 1% by mass of hydrophobic silica (number-average primary particle diameter=12 nm) and 0.3% by mass of hydrophobic titania (number-average primary particle diameter=20 nm) were added, followed by mixing with a Henschel mixer, so that toner 1 was produced.

### (B.2) Production of Toner 2

Toner 2 was produced in the same manner as the toner 1 except that the amorphous vinyl resin particle dispersion liquid X1 used in the production of the toner 1 was changed to an amorphous vinyl resin particle dispersion liquid X2.

### C. Preparation of Postprocessing Liquid

### (C.1) Preparation of Postprocessing Liquid 1

As the active ray reactive monomer, the polymerization initiator and the silicone-based compound, the following were used and mixed in the following amounts to prepare a postprocessing liquid 1.

### Active Ray Reactive Monomer

HDDA (1,6-hexanediol di (meth) acrylate): 61% by mass

TMPTA (trimethylolpropane triallylate): 30 by mass

### Polymerization Initiator

Irgacure 184 (alkylphenone): 4% by mass

Lucirin TPO (acylphosphine oxide): 4% by mass

### Silicone-Based Compound

Dimethylsiloxane: 1% by mass

Thereafter, the specific gravity [g/cm³] of the postprocessing liquid 1 was measured, and the values of the surface tension [mN/m], the interfacial tension [mN/m] to water, and the mole fractions of the ethylene oxide group and the propylene oxide group with respect to the total molar amount of dimethylsiloxane were calculated by the above-described methods. The specific gravity was 1.06 g/cm³, the surface tension was 20.2 mN/m, the interfacial tension to water was 1.3 mN/m, the mole fraction of the ethylene oxide group was 15 mol %, and the mole fraction of the propylene oxide group was 25 mol %.

### (C.2) Preparation of Postprocessing Liquids 2 to 9

As the active ray reactive monomer, the polymerization initiator and the silicone-based compound, those shown in Table III to Table V were used and mixed in the amounts shown in Table III to Table V to prepare postprocessing liquids 2 to 9.

Thereafter, the specific gravity [g/cm³] of each of the postprocessing liquids 2 to 9 were measured, and the values of the surface tension [mN/m], the interfacial tension [mN/m] to water, and the mole fractions of the ethylene oxide group and the propylene oxide group with respect to the total molar amount of dimethylsiloxane were calculated by the above-described methods.

The calculation results are shown in Table III to Table V.

The “Δρ” in Table III to Table V represents the density difference between the postprocessing liquid and water.

TABLE III

| LIQUID NO. | | LIQUID 1 | | LIQUID 2 | | LIQUID 3 | |
|---|---|---|---|---|---|---|---|
| ACTIVE RAY | ABBREVIATION | HDDA | TMPTA | HDDA | TMPTA | HDDA | TMPTA |
| REACTIVE | γ _{ML} | 8.8 | 12.9 | 8.8 | 12.9 | 8.8 | 12.9 |
| MONOMER | [mN/m] | | | | | | |
| | (*1) | | | | | | |
| | NUMBER OF | 2 | 3 | 2 | 3 | 2 | 3 |
| | FUNCTION GROUPS | | | | | | |
| | AMOUNT | 61 | 30 | 61 | 30 | 71 | 20 |
| | [mass %] | | | | | | |
| POLYMERIZATION | ABBREVIATION | Irgacure | Lucirin | Irgacure | Lucirin | Irgacure | Lucirin |
| INITIATOR | | 184 | TPO | 184 | TPO | 184 | TPO |

| | | | | | | |
|---|---|---|---|---|---|---|
| AMOUNT | 4 | 4 | 4 | 4 | 4 | 4 |
| [mass %] | | | | | | |

| SILICONE-BASED | NO. | | 1 | 2 | 3 |
|---|---|---|---|---|---|
| COMPOUND | NAME | | DIMETHYLSILOXANE | DIMETHYLSILOXANE | DIMETHYLSILOXANE |
| | R | EO[mol %] | 14 | 18 | 20 |
| | (*2) | PO[mol %] | 25 | 25 | 25 |

| AMOUNT | 1 | 1 | 1 |
|---|---|---|---|
| [mass %] | | | |

| SPECIFIC GRAVITY [g/cm³] | | 1.06 | 1.06 | 1.06 |
|---|---|---|---|---|
| | | (Δ ρ = 0.06) | (Δ ρ = 0.06) | (Δ ρ = 0. 06) |
| SURFACE TENSION | [mN/m] | 20.2 | 20.2 | 20.4 |
| (*3) | | | | |
| INTERFACIAL TENSION | | 15.1 | 12.8 | 12.1 |
| TO WATER | | | | |
| (*4) | | | | |

(*1) INTERFACIAL TENSION OF REACTIVE MONOMER TO WATER
(*2) R IN POLYETHER-MODIFIED DIMETHYLSILOXANE (EO: ETHYLENE OXIDE GROUP, PO: PROPYLENE OXIDE GROUP)
(*3) SURFACE TENSION OF LIQUID
(*4) INTERFACIAL TENSION OF LIQUID TO WATER

TABLE IV

| LIQUID NO. | | LIQUID 4 | | LIQUID 5 | | LIQUID 6 | |
|---|---|---|---|---|---|---|---|
| ACTIVE RAY | ABBREVIATION | HDDA | TMPTA | HDDA | TMPTA | HDDA | TMPTA |
| REACTIVE | γ _{ML} | 8.8 | 12.9 | 8.8 | 12.9 | 8.8 | 12.9 |
| MONOMER | [mN/m] | | | | | | |
| | (*1) | | | | | | |
| | NUMBER OF | 2 | 3 | 2 | 3 | 2 | 3 |
| | FUNCTION GROUPS | | | | | | |
| | AMOUNT | 71 | 20 | 71 | 20 | 71 | 20 |
| | [mass %] | | | | | | |
| POLYMERIZATION | ABBREVIATION | Irgacure | Lucirin | Irgacure | Lucirin | Irgacure | Lucirin |
| INITIATOR | | 184 | TPO | 184 | TPO | 184 | TPO |

| | | | | | | |
|---|---|---|---|---|---|---|
| AMOUNT | 4 | 4 | 4 | 4 | 4 | 4 |
| [mass %] | | | | | | |

| SILICONE-BASED | NO. | | 4 | 5 | 6 |
|---|---|---|---|---|---|
| COMPOUND | NAME | | DIMETHYLSILOXANE | DIMETHYLSILOXANE | DIMETHYLSILOXANE |
| | R | EO[mol %] | 25 | 40 | 50 |
| | (*2) | PO[mol %] | 25 | 25 | 20 |

| AMOUNT | 1 | 1 | 1 |
|---|---|---|---|
| [mass %] | | | |

| SPECIFIC GRAVITY [g/cm³] | 1.06 | 1.06 | 1.06 |
|---|---|---|---|
| | (Δ ρ = 0.06) | (Δ ρ = 0.06) | (Δ ρ = 0. 06) |

| SURFACE TENSION | [mN/m] | 20.4 | 20.7 | 21.0 |
|---|---|---|---|---|
| (*3) | | | | |
| INTERFACIAL TENSION | | 10.0 | 9.0 | 6.2 |
| TO WATER | | | | |
| (*4) | | | | |

(*1) INTERFACIAL TENSION OF REACTIVE MONOMER TO WATER
(*2) R IN POLYETHER-MODIFIED DIMETHYLSILOXANE (EO: ETHYLENE OXIDE GROUP, PO: PROPYLENE OXIDE GROUP)
(*3) SURFACE TENSION OF LIQUID
(*4) INTERFACIAL TENSION OF LIQUID TO WATER

TABLE V

| LIQUID NO. | | LIQUID 7 | | LIQUID 8 | | LIQUID 9 | |
|---|---|---|---|---|---|---|---|
| ACTIVE RAY | ABBREVIATION | HDDA | TMPTA | HDDA | TMPTA | PEGDA | TMPTA |
| REACTIVE | γ _{ML} | 8.8 | 12.9 | 8.8 | 12.9 | 1.2 | 12. 9 |
| MONOMER | [mN/m] | | | | | | |
| | (*1) | | | | | | |
| | NUMBER OF | 2 | 3 | 2 | 3 | 2 | 3 |
| | FUNCTION GROUPS | | | | | | |
| | AMOUNT | 71 | 20 | 71 | 20 | 71 | 20 |
| | [mass %] | | | | | | |
| POLYMERIZATION | ABBREVIATION | Irgacure | Lucirin | Irgacure | Lucirin | Irgacure | Lucirin |
| INITIATOR | | 184 | TPO | 184 | TPO | 184 | TPO |

| | | | | | | |
|---|---|---|---|---|---|---|
| AMOUNT | 4 | 4 | 4 | 4 | 4 | 4 |
| [mass %] | | | | | | |

| SILICONE-BASED | NO. | | 7 | 8 | 4 |
|---|---|---|---|---|---|
| COMPOUND | NAME | | DIMETHYLSILOXANE | DIMETHYLSILOXANE | DIMETHYLSILOXANE |
| | R | EO[mol%] | 55 | 60 | 25 |
| | (*2) | PO[mol %] | 20 | 20 | 25 |

| AMOUNT | 1 | 1 | 1 |
|---|---|---|---|
| [mass %] | | | |

| SPECIFIC GRAVITY [g/cm³] | | 1.06 | 1.06 | 1.12 |
|---|---|---|---|---|
| | | (Δ ρ = 0.06) | (Δ ρ = 0.06) | (Δ ρ = 0.12) |
| SURFACE TENSION | [mN/m] | 21.0 | 21.3 | 21.6 |
| (*3) | | | | |
| INTERFACIAL TENSION | | 2.3 | 1.3 | 1.1 |
| TO WATER | | | | |
| (*4) | | | | |

(*1) INTERFACIAL TENSION OF REACTIVE MONOMER TO WATER
(*2) R IN POLYETHER-MODIFIED DIMETHYLSILOXANE (EO: ETHYLENE OXIDE GROUP, PO: PROPYLENE OXIDE GROUP)
(*3) SURFACE TENSION OF LIQUID
(*4) INTERFACIAL TENSION OF LIQUID TO WATER

### D. Evaluation

### (D.1) Formation of Image

A recording medium and a printing material were set in the above-described image forming apparatus “Accurio C6100” (electrophotographic method) to form each fixed image undor image forming conditions 1 below.

### Image Forming Conditions 1

Sheet Passing Speed: 400 mm/sec

Recording Medium (paper type): POD-156 gloss coat paper (manufactured by Oji Paper Co., Ltd)

Printing Material Containing Wax: Toner 1 or Toner 2

Adhesion amount of Toner 1 or Toner 2 to Image: 8 g/m²

In Example 9 shown in Table VIII, the recording medium and the printing material were set in an image forming apparatus “Accurio Jet KM-1e” (inkjet method) to form a fixed image under image forming conditions 2 below.

### Image Forming Conditions 2

Sheet Passing Speed: 400 mm/sec

Recording Medium (paper type): POD-156 gloss coat paper (manufactured by Oji Paper Co., Ltd)

Printing Material Containing Wax: Ink of Product of “Accurio Jet KM-1e” (wherein the ink contains ester-based wax as a gelling material)

Adhesion Amount of Toner 1 to Image: 10 g/m²

### (D.2) Postprocessing

Thereafter, each fixed image was set again in the above-described image forming apparatus, and as postprocessing, with a sheet passing speed of 250 mm/sec., the postprocessing liquids 1 to 9 listed in Table III to Table V were respectively applied to the fixed images with an applying amount of 6 g/m² using a UV varnish coater “Digi UV Coater” (manufactured by BN Technologies, Inc). Thus, layers [1] to [9] of the postprocessing liquids having a coating thickness of about 5 μm were formed.

Note that as for the postprocessing liquid 4, when the postprocessing liquid 4 was applied, a layer [4-1] of the postprocessing liquid having a coating thickness of about 1 μm, a layer [4-2] of the postprocessing liquid having a coating thickness of about 10 μm, and a layer [4-3] of the postprocessing liquid having a coating thickness of about 0.8 μm were also formed.

Two seconds later after the layers [1] to [9], [4-1], [4-2] and [4-3] of the postprocessing liquids were formed, the layers were cured by irradiation with ultraviolet rays at 120 W/cm to form cured films «1» to «9», «4-1», «4-2» and «4-3» of the postprocessing liquids on the fixed images.

### Application Property

### Evaluation Method

The surface condition of each of the cured films «1» to «9». «4-1», «4-2» and «4-3» formed on the fixed images was observed with a microscope (fiftyfold), and the application property (wettability) of each of the postprocessing liquids to the fixed images was evaluated in accordance with the following evaluation criteria. In the following evaluation criteria, B or higher was determined to have no practical problem (pass). The evaluation results are shown in Table VI to Table X.

### Evaluation Criteria

A: No Pin Hole in Area of 1 cm×1 cm (Pass)

B: 1 to 2 Fine Pinholes in Area of 1 cm×1 cm (Pass).

C: 3 to 10 Fine Pinholes in Area of 1 cm×1 cm (Fail)

D: 11 or More Pinholes in Area of 1 cm×1 cm, or Repelled (Fail).

### (D.3) Re-Postprocessing

To each of the cured films «1» to «9», «4-1», «4-2» and «4-3» formed on the fixed images. as re-postprocessing, a metallic foil (silver) of Murata Kinzoku was attached by heat and pressure using a foil pressing machine (hot stamp method).

Conditions of the re-postprocessing are as follows.

### Conditions

Foil Pressing Pressure: 200 kPa

Foil Pressing Temperature: 120° C.

Foil Pressing Time: 0.4 sec

### Adhesiveness

### Evaluation Method

The adhesiveness of each re-postprocessed fixed image was evaluated using a mending tape peeling method. The procedure of the evaluation using the mending tape peeling method is as described in (1) to (7) below.

(1) Take a photograph of each re-postprocessed fixed image at a magnification of 100 times using a digital microscope VHX-6000 manufactured by Keyence Corporation, and perform binarization using LUSEX-AP manufactured by Nireco Corporation.

(2) Lightly stuck “Mending Tape” (manufactured by Sumitomo 3M Limited: No. 810-3-12) to the re-postprocessed fixed image.

(3) Rub back and forth 3.5 times on the tape with a pressure of 1 kPa.

(4) Remove the tape with a force of 200 g at an angle of 180 degrees.

(5) Take a photograph of the re-postprocessed fixed image after the peeling at a magnification of 100 times using a digital microscope VHX-6000 manufactured by Keyence Corporation, and perform binarization using LUSEX-AP manufactured by Nireco Corporation.

(6) Calculate the fixing rate of the foil to the postprocessing liquid by the following formula.

Fixing Rate [%] of Foil to Postprocessing Liquid=(Contrast Ratio of Postprocessing Liquid to Image Region of Resin after Tape Peeling/Contrast Ratio of Powder to Image Region of Resin before Tape Peeling)×100

(7) Evaluate the adhesiveness in accordance with the following evaluation criteria. In the following evaluation criteria, B or higher was determined to have no practical problem (pass). The evaluation results are shown in Table VI to Table X.

### Evaluation Criteria

A: Fixing Rate of Postprocessing Liquid of Less than 1% (Pass)

B: Fixing Rate of Postprocessing Liquid of 1% or More and Less than 10% (Pass)

C: Fixing Rate of Postprocessing Liquid of More than 10% (Fail)

D: Impossible to Judge Adhesiveness with Mending Tape Peeling Method due to Too Poor Application Property of Postprocessing Liquid (Fail)

E. Overall Assessment

As clearly seen from Table VI to Table X. the present invention is excellent in application property of a postprocessing liquid to a fixed image, and is excellent in adhesiveness after application of the postprocessing liquid.

TABLE VI

| EXAMPLE OR COMPARATIVE EXAMPLE | | | | EXAMPLE 1 | | EXAMPLE 2 | | EXAMPLE 3 | |
|---|---|---|---|---|---|---|---|---|---|
| IMAGE | | | NO. | 1 | | 1 | | 1 | |
| FORMING | TONER | | WAX | ESTER-BASED | | ESTER-BASED | | ESTER-BASED | |
| STEP | METHOD | | | ELECTROPHO- | | ELECTROPHO- | | ELECTROPHO- | |
| | | | | TOGRAPHIC | | TOGRAPHIC | | TOGRAPHIC | |
| POSTPROCESSING | LIQUID | LIQUID NO. | | LIQUID 2 | | LIQUID 3 | | LIQUID 4 | |
| STEP | | ACTIVE RAY | ABBREVIATION | HDDA | TMPTA | HDDA | TMPTA | HDDA | TMPTA |
| | | REACTIVE | γ_{ML} | 8.8 | 12.9 | 8.8 | 12.9 | 8.8 | 12.9 |
| | | MONOMER | [mN/m] (*1) | | | | | | |
| | | | NUMBER OF | 2 | 3 | 2 | 3 | 2 | 3 |
| | | | FUNCTION GROUPS | | | | | | |
| | | | AMOUNT | 71 | 20 | 71 | 20 | 71 | 20 |
| | | | [mass %] | | | | | | |

| SILICONE- | NO. | | 2 | 3 | 4 |
|---|---|---|---|---|---|
| BASED | R (*2) | E0 [mol %] | 18 | 20 | 25 |
| COMPOUND | | P0 [mol %] | 25 | 25 | 25 |

| | | | | |
|---|---|---|---|---|
| SURFACE TENSION (*3) | [mN/m] | 20.4 | 20.4 | 20.4 |
| INTERFACIAL TENSION | | 12.8 | 12.1 | 10.0 |
| TO WATER (*4) | | | | |

| | | | | | |
|---|---|---|---|---|---|
| | LAYER OF | NO. | (2) | (3) | (4) |
| | LIQUID | COATING THICKNESS [μm] | 5 | 5 | 5 |
| RE- | CURED FILM | NO. | (2) | (3) | (4) |
| POSTPROCESSING | OF LIQUID | | | | |

| | | | | |
|---|---|---|---|---|
| STEP | METHOD | HOT STAMP | HOT STAMP | HOT STAMP |
| EVALUATION | APPLICATION PROPERTY | B | A | A |
| | ADHESIVENESS | B | A | A |

(*1) INTERFACIAL TENSION OF REACTIVE MONOMER TO WATER
(*2) R IN POLYETHER-MODIFIED DIMETHYLSILOXANE (E0: ETHYLENE OXIDE GROUP, P0: PROPYLENE OXIDE GROUP)
(*3) SURFACE TENSION OF LIQUID
(*4) INTERFACIAL TENSION OF LIQUID TO WATER

TABLE VII

| EXAMPLE OR COMPARATIVE EXAMPLE | | | | EXAMPLE 4 | | EXAMPLE 5 | | EXAMPLE 6 | |
|---|---|---|---|---|---|---|---|---|---|
| IMAGE FORMING | TONER | | NO. | 1 | | 2 | | 1 | |
| STEP | | | WAX | ESTER-BASED | | HYDROCARBON-BASED | | ESTER-BASED | |
| | METHOD | | | ELECTROPHO- | | ELECTROPHO- | | ELECTROPHO- | |
| | | | | TOGRAPHIC | | TOGRAPHIC | | TOGRAPHIC | |
| POSTPROCESSING | LIQUID | LIQUID NO. | | LIQUID 5 | | LIQUID 6 | | LIQUID 7 | |
| STEP | | ACTIVE RAY | ABBREVIATION | HDDA | TMPTA | HDDA | TMPTA | HDDA | TMPTA |
| | | REACTIVE | γ_{ML} | 8.8 | 12.9 | 8.8 | 12.9 | 8.8 | 12.9 |
| | | MONOMER | [mN/m] (*1) | | | | | | |
| | | | NUMBER OF | 2 | 3 | 2 | 3 | 2 | 3 |
| | | | FUNCTION GROUPS | | | | | | |
| | | | AMOUNT | 71 | 20 | 71 | 20 | 71 | 20 |
| | | | [mass %] | | | | | | |

| SILICONE- | NO. | | 5 | 6 | 7 |
|---|---|---|---|---|---|
| BASED | R (*2) | E0 [mol %] | 40 | 50 | 55 |
| COMPOUND | | P0 [mol %] | 25 | 20 | 20 |

| | | | | |
|---|---|---|---|---|
| SURFACE TENSION (*3) | [mN/m] | 20.7 | 21.0 | 21.0 |
| INTERFACIAL TENSION | | 9.0 | 6.2 | 2.3 |
| TO WATER (*4) | | | | |

| | | | | | |
|---|---|---|---|---|---|
| | LAYER OF | NO. | (5) | (6) | (7) |
| | LIQUID | COATING THICKNESS [μm] | 5 | 5 | 5 |
| RE- | CURED FILM | NO. | (5) | (6) | (7) |
| POSTPROCESSING | OF LIQUID | | | | |

| | | | | |
|---|---|---|---|---|
| STEP | METHOD | HOT STAMP | HOT STAMP | HOT STAMP |
| EVALUATION | APPLICATION PROPERTY | A | A | B |
| | ADHESIVENESS | A | B | B |

(*1) INTERFACIAL TENSION OF REACTIVE MONOMER TO WATER
(*2) R IN POLYETHER-MODIFIED DIMETHYLSILOXANE (E0: ETHYLENE OXIDE GROUP, P0: PROPYLENE OXIDE GROUP)
(*3) SURFACE TENSION OF LIQUID
(*4) INTERFACIAL TENSION OF LIQUID TO WATER

TABLE VIII

| EXAMPLE OR COMPARATIVE EXAMPLE | | | | EXAMPLE 7 | | EXAMPLE 8 | | EXAMPLE 9 | |
|---|---|---|---|---|---|---|---|---|---|
| IMAGE FORMING | TONER | | NO. | 1 | | 1 | | 1 | |
| STEP | | | WAX | ESTER-BASED | | ESTER-BASED | | ESTER-BASED | |
| | METHOD | | | ELECTROPHO- | | ELECTROPHO- | | ELECTROPHO- | |
| | | | | TOGRAPHIC | | TOGRAPHIC | | TOGRAPHIC | |
| POSTPROCESSING | LIQUID | LIQUID NO. | | LIQUID 4 | | LIQUID 4 | | LIQUID 4 | |
| STEP | | ACTIVE RAY | ABBREVIATION | HDDA | TMPTA | HDDA | TMPTA | HDDA | TMPTA |
| | | REACTIVE | γ_{ML} | 8.8 | 12.9 | 8.8 | 12.9 | 8.8 | 12.9 |
| | | MONOMER | [mN/m] (*1) | | | | | | |
| | | | NUMBER OF | 2 | 3 | 2 | 3 | 2 | 3 |
| | | | FUNCTION GROUPS | | | | | | |
| | | | AMOUNT | 71 | 20 | 71 | 20 | 71 | 20 |
| | | | [mass %] | | | | | | |

| SILICONE- | NO. | | 4 | 4 | 4 |
|---|---|---|---|---|---|
| BASED | R (*2) | E0 [mol %] | 25 | 25 | 25 |
| COMPOUND | | P0 [mol %] | 25 | 25 | 25 |

| | | | | |
|---|---|---|---|---|
| SURFACE TENSION (*3) | [mN/m] | 20.4 | 20.4 | 20.4 |
| INTERFACIAL TENSION | | 10.0 | 10.0 | 10.0 |
| TO WATER (*4) | | | | |

| | | | | | |
|---|---|---|---|---|---|
| | LAYER OF | NO. | (4-1) | (4-2) | (4-3) |
| | LIQUID | COATING THICKNESS [μm] | 1 | 10 | 0.8 |
| RE- | CURED FILM | NO. | (4-1) | (4-2) | (4-3) |
| POSTPROCESSING | OF LIQUID | | | | |

| | | | | |
|---|---|---|---|---|
| STEP | METHOD | HOT STAMP | HOT STAMP | HOT STAMP |
| EVALUATION | APPLICATION PROPERTY | A | A | B |
| | ADHESIVENESS | A | A | A |

(*1) INTERFACIAL TENSION OF REACTIVE MONOMER TO WATER
(*2) R IN POLYETHER-MODIFIED DIMETHYLSILOXANE (E0: ETHYLENE OXIDE GROUP, P0: PROPYLENE OXIDE GROUP)
(*3) SURFACE TENSION OF LIQUID
(*4) INTERFACIAL TENSION OF LIQUID TO WATER

TABLE IX

| EXAMPLE OR COMPARATIVE EXAMPLE | | | | EXAMPLE 10 | |
|---|---|---|---|---|---|
| IMAGE FORMING | TONER | | NO. | 1 | |
| STEP | | | WAX | ESTER-BASED | |
| | METHOD | | | INKJET | |
| POSTPROCESSING | LIQUID | LIQUID NO. | | LIQUID 5 | |
| STEP | | ACTIVE RAY | ABBREVIATION | HDDA | TMPTA |
| | | REACTIVE | γ_{ML} [mN/m] (*1) | 8.8 | 12.9 |
| | | MONOMER | NUMBER OF FUNCTION | 2 | 3 |
| | | | GROUPS | | |
| | | | AMOUNT [mass %] | 71 | 20 |

| SILICONE-BASED | NO. | | 5 |
|---|---|---|---|
| COMPOUND | R (*2) | E0 [mol %] | 40 |
| | | P0 [mol %] | 25 |

| | | |
|---|---|---|
| SURFACE TENSION (*3) | [mN/m] | 20.4 |
| INTERFACIAL TENSION TO WATER (*4) | | 9.0 |

| | | | |
|---|---|---|---|
| | LAYER OF | NO. | (5) |
| | LIQUID | COATING THICKNESS [μm] | 5 |
| RE- | CURED FILM | NO. | (5) |
| POSTPROCESSING | OF LIQUID | | |

| | | |
|---|---|---|
| STEP | METHOD | HOT STAMP |
| EVALUATION | APPLICATION PROPERTY | B |
| | ADHESIVENESS | A |

(*1) INTERFACIAL TENSION OF REACTIVE MONOMER TO WATER
(*2) R IN POLYETHER-MODIFIED DIMETHYLSILOXANE (E0: ETHYLENE OXIDE GROUP, P0: PROPYLENE OXIDE GROUP)
(*3) SURFACE TENSION OF LIQUID
(*4) INTERFACIAL TENSION OF LIQUID TO WATER

TABLE X

| | | | | COMPARATIVE | | COMPARATIVE | | COMPARATIVE | |
|---|---|---|---|---|---|---|---|---|---|
| EXAMPLE OR COMPARATIVE EXAMPLE | | | | EXAMPLE 1 | | EXAMPLE 2 | | EXAMPLE 3 | |
| IMAGE | TONER | | NO. | 1 | | 1 | | 1 | |
| FORMING | | | WAX | ESTER-BASED | | ESTER-BASED | | ESTER-BASED | |
| STEP | METHOD | | | ELECTROPHO- | | ELECTROPHO- | | ELECTROPHO- | |
| | | | | TOGRAPHIC | | TOGRAPHIC | | TOGRAPHIC | |
| POSTPROCESSING | LIQUID | LIQUID NO. | | LIQUID 1 | | LIQUID 8 | | LIQUID 9 | |
| STEP | | ACTIVE RAY | ABBREVIATION | HDDA | TMPTA | HDDA | TMPTA | HDDA | TMPTA |
| | | REACTIVE | γ_{ML} | 8.8 | 12.9 | 8.8 | 12.9 | 1.2 | 12.9 |
| | | MONOMER | [mN/m] (*1) | | | | | | |
| | | | NUMBER OF | 2 | 3 | 2 | 3 | 2 | 3 |
| | | | FUNCTION GROUPS | | | | | | |
| | | | AMOUNT AMOUNT | 61 | 30 | 71 | 20 | 71 | 20 |
| | | | [mass %] | | | | | | |

| SILICONE- | NO. | | 1 | 8 | 4 |
|---|---|---|---|---|---|
| BASED | R (*2) | E0 [mol %] | 14 | 60 | 25 |
| COMPOUND | | P0 [mol %] | 25 | 20 | 25 |

| | | | | |
|---|---|---|---|---|
| SURFACE TENSION (*3) | [mN/m] | 20.2 | 21.3 | 21.6 |
| INTERFACIAL TENSION | | 15.1 | 1.3 | 1.1 |
| TO WATER (*4) | | | | |

| | | | | | |
|---|---|---|---|---|---|
| | LAYER OF | NO. | (1) | (8) | (9) |
| | LIQUID | COATING THICKNESS [μm] | UNMEASURABLE | 5 | UNMEASURABLE |
| RE- | CURED FILM | NO. | (1) | (8) | (9) |
| POSTPROCESSING | OF LIQUID | | | | |

| | | | | |
|---|---|---|---|---|
| STEP | METHOD | HOT STAMP | HOT STAMP | HOT STAMP |
| EVALUATION | APPLICATION PROPERTY | D | C | D |
| | ADHESIVENESS | D | C | D |

(*1) INTERFACIAL TENSION OF REACTIVE MONOMER TO WATER
(*2) R IN POLYETHER-MODIFIED DIMETHYLSILOXANE (E0: ETHYLENE OXIDE GROUP, P0: PROPYLENE OXIDE GROUP)
(*3) SURFACE TENSION OF LIQUID
(*4) INTERFACIAL TENSION OF LIQUID TO WATER

Although one or more embodiments of the present disclosure have been described and illustrated in detail. the disclosed embodiments or the like are made for purposes of not limitation but illustration and example only. The scope of the present invention should be interpreted by terms of the appended claims.

1. An image forming method comprising:
forming an image with a printing material containing a wax on a recording medium:
applying a postprocessing liquid onto the image as postprocessing; and
forming a layer of the postprocessing liquid,
wherein an interfacial tension of the postprocessing liquid to water is within a range of 2 to 13 mN/m at 25° C.

2. The image forming method according to claim 1, wherein a surface tension of the postprocessing liquid is within a range of 18 to 25 mN/m at 25° C.

3. The image forming method according to claim 1,
wherein the postprocessing liquid is a photocurable postprocessing liquid containing an active ray reactive monomer, a polymerization initiator and a silicone-based compound, and
wherein the image forming method further comprises curing the layer of the postprocessing liquid by irradiating the layer with an active ray.

4. The image forming method according to claim 1, wherein the image is formed by an electrophotographic method or an inkjet method.

5. The image forming method according to claim 3, wherein the silicone-based compound is dimethylsiloxane having an ethylene oxide group in a side chain.

6. The image forming method according to claim 5, wherein a mole fraction of the ethylene oxide group is within a range of 20 to 50% with respect to a total molar amount of the dimethylsiloxane.

7. The image forming method according to claim 3, wherein an interfacial tension of the active ray reactive monomer to water is within a range of 2 to 20 mN/m at 25° C.

8. The image forming method according to claim 3, wherein the active ray reactive monomer contains a bifunctional active ray reactive monomer having an alkyl group in a main chain within a range of 40 to 80 mass % with respect to a total amount of the postprocessing liquid.

9. The image forming method according to claim 1, wherein a surface tension of the image is within a range of 18 to 30 mN/m at 25° C.

10. The image forming method according to claim 1, wherein a surface tension of the image is within a range of 18 to 25 mN/m at 25° C.

11. The image forming method according to claim 1, wherein the printing material contains, as the wax, a hydrocarbon-based or ester-based wax.

12. The image forming method according to claim 1, wherein the interfacial tension of the postprocessing liquid to water is within a range of 2 to 10 mN/m at 25° C.

13. The image forming method according to claim 1, further comprising performing re-postprocessing on the layer of the postprocessing liquid or a cured film of the postprocessing liquid.

14. The image forming method according to claim 1, wherein the image is formed by a roll-to-roll method.

15. The image forming method according to claim 1, wherein a thickness of a cured film of the postprocessing liquid is within a range of 1 to 10 mm.

16. An image forming system comprising:
an apparatus that forms an image with a printing material containing a wax on a recording medium;
an apparatus that applies a postprocessing liquid onto the image as postprocessing; and
an apparatus that forms a layer of the postprocessing liquid,
wherein an interfacial tension of the postprocessing liquid to water is within a range of 2 to 13 mN/m at 25° C.

17. A postprocessing liquid that is used in the image forming method according to claim 1, wherein an interfacial tension of the postprocessing liquid to water is within a range of 2 to 13 mN/m at 25° C.

18. A postprocessing liquid applying apparatus that is used in the image forming method according to claim 1, wherein the postprocessing liquid applying apparatus applies a postprocessing liquid onto an image formed with a printing material containing a wax.
